(19) United States
(12) Patent Application Publication
(10) Pub. No.: US 2025/0182318 A1
(43) Pub. Date: Jun. 5, 2025

(54) INFORMATION TERMINAL APPARATUS AND POSITION RECOGNITION SHARING METHOD

(71) Applicant: MAXELL, LTD., Kyoto (JP)

(72) Inventors: Yasunobu HASHIMOTO, Kyoto (JP); Naohisa TAKAMIZAWA, Kyoto (JP)

(21) Appl. No.: 19/047,863

(22) Filed: Feb. 7, 2025

Related U.S. Application Data
(63) Continuation of application No. 17/634,582, filed on Feb. 11, 2022.

(51) Int. Cl. G06T 7/70; G02B 27/01; H04W 4/02

(52) U.S. Cl. CPC G06T 7/70; G02B 27/0176; H04W 4/026; G02B 2027/0178

(57) ABSTRACT

An information terminal apparatus is capable of realizing position recognition sharing among terminals even where there is no suitable real object that becomes an anchor in a real space. An information terminal apparatus to be carried or worn by a user has a function of displaying an image and is configured to execute sharing of position recognition with another terminal in a real space. Sharing of the position information is executed by conversion between coordinate systems (WA) and (WB) of the terminals by using data containing specific direction information (N_{A}, N_{B}) in the real space of the own terminal and the other terminal and terminal position information (d_{A}, d_{B}, P_{BA}, P_{AB}) that is information regarding positions in the real space as data containing a relationship of relative orientation between the coordinate systems of the terminals and information regarding a relative positional relationship between origins of the coordinate systems.

### TECHNICAL FIELD

The present invention relates to a technology of an information terminal apparatus and a position recognition sharing method.

### BACKGROUND ART

Various types of information terminal apparatuses that can be moved with a user by being worn or carried by the user, such as a head mounted display (Head Mounted Display: HMD), a smartphone, and a tablet terminal, are provided. Some information terminal apparatuses have a function of displaying an image, such as a virtual object, related to virtual reality (VR), augmented reality (AR), or the like on a display surface corresponding to a field of view of a user. This terminal has a coordinate system as a reference for displaying an image.

Further, it is also proposed a technology that, in a case where a plurality of users respectively has information terminal apparatuses, position recognition in a real space is shared among those terminals, and an image of the same virtual object or the like is to be displayed at the same position. This technology is expected to be useful for various applications including work support and entertainment.

As an example of a conventional technology related to the above, Japanese Patent Application Publication No. 2014-514653 (Patent document 1) can be mentioned. Patent document 1 describes a technology that the same object, for example, a desk surface in a real space is recognized as an anchor surface by a plurality of terminals on the basis of capture of a camera, and a virtual object is displayed at almost the same position by displaying the virtual object on the anchor surface from each of the terminals.

### RELATED ART DOCUMENTS

### Patent Documents

Patent document 1: Japanese Patent Application Publication No. 2014-514653

### SUMMARY OF THE INVENTION

### Problems to be Solved by the Invention

A system including an information terminal apparatus of a conventional technology example has a problem in order to share position recognition in a real space among a plurality of terminals. Basically, each terminal has a different coordinate system. Under this premise, it is impossible to share position recognition among the terminals. Therefore, it is necessary to take some measures, such as a system for sharing a reference coordinate system among the terminals, so as to allow position recognition sharing on the basis of different coordinate systems of the respective terminals, for example.

The system of the conventional technology example such as Patent document 1 requires, for the position recognition sharing, appropriate real objects (for example, a desk surface), which become anchors or marks to be fixed, at appropriate locations around a terminal in a real space. In an environment or situation where there are no such real objects, the position recognition sharing is impossible. In the conventional technology example, there is no consideration for dealing with such a case, and there are many restrictions on the position recognition sharing.

It is an object of the present invention to provide a technology for an information terminal apparatus capable of realizing position recognition sharing among terminals even in a case where there is no suitable real object that becomes an anchor or the like in a real space with respect to a technology of an information terminal apparatus and the like. Problems other than the above will be described in embodiments.

### Means for Solving the Problem

A representative embodiment of the present invention has a configuration described below. An information terminal apparatus according to one embodiment is an information terminal apparatus to be carried or worn by a user, the information terminal apparatus having a function of displaying an image on a display surface. Here, the information terminal apparatus is used as a first terminal, and at least one other information terminal apparatus is used as a second terminal. In a case where sharing of position recognition is to be executed between the first terminal and the second terminal in a real space, the sharing of the position recognition is executed by conversion between a first coordinate system of the first terminal and a second coordinate system of the second terminal by using data containing information regarding a relationship of relative orientation between the first coordinate system of the first terminal and the second coordinate system of the second terminal and information regarding a relative positional relationship between origins of the first and second coordinate systems.

### Effects of the Invention

According to the representative embodiment of the present invention, it is possible to realize position recognition sharing among terminals even in a case where there is no suitable real object that becomes an anchor or the like in a real space with respect to a technology of an information terminal apparatus and the like.

### BRIEF DESCRIPTIONS OF THE DRAWINGS

FIG. 1 is a configuration example of a position recognition sharing system that includes an information terminal apparatus according to a first embodiment of the present invention;

FIG. 2 is a view illustrating an example of an appearance configuration of an HMD that is the information terminal apparatus according to the first embodiment;

FIG. 3 is a view illustrating an example of a functional block configuration of the HMD that is the information terminal apparatus according to the first embodiment;

FIG. 4 is a view illustrating a configuration example of a controller in the information terminal apparatus according to the first embodiment;

FIG. 5 is a view illustrating a coordinate system between terminals and amounts according to the first embodiment;

FIG. 6 is a view illustrating each example of conversion at the time of transmission of positions between the terminals and conversion parameters according to the first embodiment;

FIG. 7 is a view illustrating an AR image display example in a case where the information terminal apparatus according to the first embodiment is a smartphone;

FIG. 8 is a view illustrating a control flow between the terminals according to the first embodiment;

FIG. 9 is a view illustrating an output example at the time of coordinate system pairing between the terminals according to the first embodiment;

FIGS. 10(A)-10(B) are an explanatory drawing regarding conversion and rotation of the coordinate system according to the first embodiment;

FIGS. 11(A)-11(B) are views illustrating an example of position specification in a real space according to the first embodiment;

FIGS. 12(A)-12(B) are views illustrating an application example of position specification according to the first embodiment;

FIG. 13 is a view illustrating measurement at the time of coordinate system pairing according to a modification example of the first embodiment;

FIGS. 14(A)-14(B) are views illustrating a configuration example of a position recognition sharing system including an information terminal apparatus according to a second embodiment of the present invention;

FIG. 15 is a view illustrating a configuration example of a position recognition sharing system including an information terminal apparatus according to a third embodiment of the present invention;

FIG. 16 is a view illustrating an example of simultaneous coordinate system pairing with a plurality of terminals according to a modification example of the third embodiment;

FIG. 17 is a view illustrating a configuration example of a position recognition sharing system including an information terminal apparatus according to a fourth embodiment of the present invention;

FIG. 18 is a view illustrating a configuration example conversion parameters according to the fourth of embodiment; and

FIG. 19 is a view illustrating a configuration example of conversion parameters according to a modification example of the fourth embodiment.

### DETAILED DESCRIPTION OF EMBODIMENTS

Hereinafter, embodiments of the present invention will be described in detail with reference to the drawings. Note that in all drawings for explaining embodiments, the same reference numerals are respectively in principle applied to the same portions, and repeated explanation thereof will be omitted.

### First Embodiment

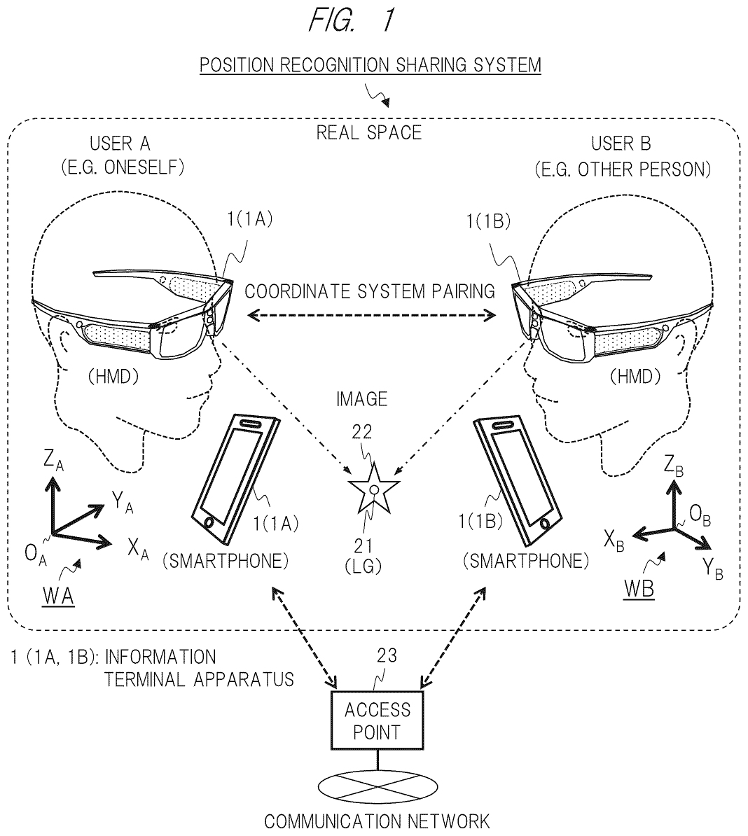

A position recognition sharing system and a method thereof, which includes an information terminal apparatus according to a first embodiment of the present invention, will be described with reference to FIG. 1 to FIG. 13. Note that the information terminal apparatus may be described a terminal. The information terminal apparatus according to the first embodiment has a function for position recognition sharing between terminals. position recognition sharing method according to the first embodiment is a method including steps executed by the information terminal apparatus according to the first embodiment.

The position recognition sharing system and the method thereof, which include the information terminal apparatus according to the first embodiment, associate coordinate systems of respective terminals with each other, for example, between two terminals of an own terminal and the other terminal by using information regarding a relationship of relative orientations between coordinate systems of the respective terminals and information regarding a relative positional relationship between respective coordinate system origins. In other words, conversion between the coordinate systems is executed using these types of information. As a result, this system and this method execute sharing of position recognition. Here, the information regarding the relationship of the relative orientations between the coordinate systems of the respective terminals is information regarding two specific directions of different orientations in a real space regarding the respective terminals (specific direction information), for example. Further, the information regarding the relative positional relationship between the respective coordinate system origins is information regarding positions of the respective terminals (terminal position information), for example. Rotation for converting the orientations between the coordinate systems of the respective terminals can be obtained from the information on the two specific directions of the orientations, and a relationship between origins of the respective coordinate systems can be obtained from the terminal position information. Conversion parameters of the coordinate systems can be obtained from these kinds of information, and this makes it possible to share position recognition. Among the terminals each of which becomes a state where the position recognition is shared, it is possible to share the same position in the real space each other. For example, one terminal specifies a display target position of an image to the other terminal, whereby the respective terminals can display the same image at the same position thus specified.

In the first embodiment, as one of the specific direction information, specific directional vectors (N_{A}, N_{B}) in a vertical downward direction, which will be described later (FIG. 5), are used. The terminal position information is information that combines position information representing a position of the other terminal based on a first coordinate system of an own terminal (a coordinate value d_{A} of the own terminal and an inter-terminal vector P_{BA}), and position information representing a position of the own terminal based on a second coordinate system of the other terminal (a coordinate value d_{B} of the other terminal and an inter-terminal vector P_{AB}). In the first embodiment, the inter-terminal vector is information related to two of another specific direction information and the position information of the other terminal based on the coordinate system of the own terminal.

### [Position Recognition Sharing System]

FIG. 1 illustrates a configuration of the position recognition sharing system that includes the information terminal apparatus according to the first embodiment. This position recognition sharing system includes a plurality of information terminal apparatuses 1 that is the information terminal apparatus according to the first embodiment in a real space. In the present example, the position recognition sharing system has information terminal apparatuses 1A, 1B as two terminals. This position recognition sharing system is a system in which position recognition in the real space is shared between the plurality of information terminal apparatuses 1, and is a display system capable of displaying an image such as the same virtual object at the same shared position. The terminals 1 (1A, 1B) may be an HMD such as a smart glass, or may be a smartphone or a tablet terminal. In the present embodiment, a user A (for example, himself or herself) wears an HMD as the terminal 1A, and a user B (for example, another person) wears an HMD as the terminal 1B. Position recognition sharing is executed between the terminals 1A, 1B of the users A, B. A type of the terminal 1 is not limited so long as it is a device that includes a function necessary for the position recognition sharing. Position recognition sharing is also possible with a combination of different types of terminals 1.

When position recognition sharing is executed from a state before the position recognition sharing, the terminals 1 (1A, 1B) execute coordinate system pairing therebetween as an operation involving communication between the terminals. The coordinate system pairing is an operation including exchange of amounts (will be described later), and setting of conversion parameters for conversion between coordinate systems. The coordinate system pairing causes the coordinate systems of the respective terminals 1 to be associated with each other, whereby they become a state where position recognition is shared between the terminals 1. In this state, it is possible to display an image 22 such as the same virtual object in the real space by using the same position 21 when viewed from each of the terminals 1 (1A, 1B) as a display target position LG.

Each of the terminals 1 has a wireless communication function and an image displaying function. Each of the terminals 1 is wirelessly connected to an access point 23 or the like on a communication network, and can execute wireless communication between the terminals 1 and communication with a device such as a server on the communication network. Each of the terminals 1 may generate image data such as a virtual object, or may obtain image data and the like from a device on the communication network.

### [Information Terminal Apparatus (HMD)]

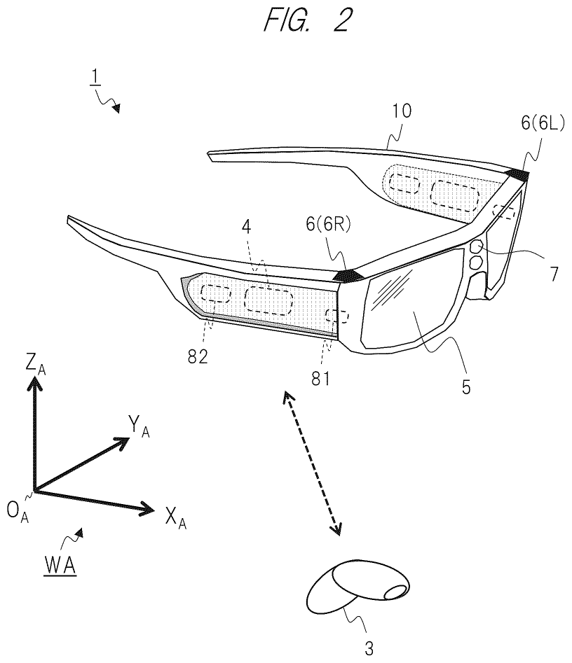

FIG. 2 illustrates an example of an appearance configuration of the HMD as an example of the information terminal apparatus 1. This HMD includes a display device in which display surfaces 5 are provided in a spectacle-shaped chassis 10. This display device is a transmission type display device, for example. A real image of the outside world is transmitted to the display surfaces 5, and an image such as a virtual object is superimposed and displayed on the real image. The chassis 10 includes a sensor unit 4, a camera 6, a distance measuring sensor 7, and the like. The sensor unit 4 is a position attitude sensor that includes a group of sensors for detecting a state of a position and an attitude of the HMD. The camera 6 has cameras 6R and 6L arranged on both right and left sides of the chassis 10, for example, and captures a range including the front of the HMD to obtain an image. The distance measuring sensor 7 is a sensor that measures a distance between the HMD and an object in the outside world. As the distance measuring sensor 7, a TOF (Time Of Flight) type sensor may be used, or a stereo camera or another type may be used. Further, microphones 81 and speakers 82 are provided on the right and left sides of the chassis 10.

An operating device 3 such as a remote controller may be attached to the terminal 1. The terminal 1 executes short-range wireless communication with the operating device 3, for example. The user can input an instruction regarding the function of the HMD or move a cursor by operating the operating device 3 by his or her hand. The HMD that is the terminal 1 may communicate with an external smartphone or the like to cooperate with each other. For example, the HMD may receive image data from an application provided with the smartphone.

The terminal 1 includes an application program for causing the display surface 5 to display an image such as a virtual object for work support or entertainment as an element of the image displaying function. For example, the terminal 1 generates an image for the work support by processing an application for the work support, and arranges and displays the image at a predetermined position in the vicinity of a work object in the real space on the display surface 5.

The terminal 1 has a coordinate system (which may be described as a world coordinate system) as a reference for displaying an image. In the present embodiment, this HMD has a world coordinate system WA. The world coordinate system WA has an axis X_{A}, an axis Y_{A}, and an axis Z_{A} as three orthogonal axes at an origin O_{A}. The origin O_{A} is fixed at a predetermined position in the real space.

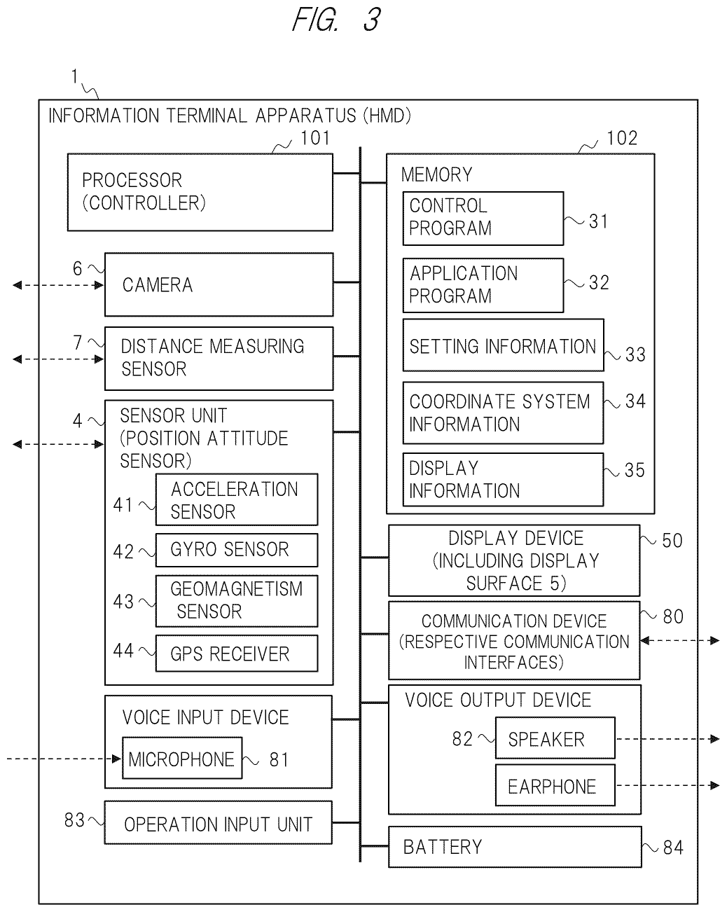

FIG. 3 illustrates an example of a functional block configuration of the information terminal apparatus 1 in a case where it is the HMD illustrated in FIG. 2. The terminal 1 includes a processor 101, a memory 102, the camera 6, the distance measuring sensor 7, the sensor unit 4, a display device 50, a communication device 80, a voice input device including the microphone 81, a voice output device including the speaker 82 or an earphone, an operation input unit 83, a battery 84, and the like. These elements are connected to each other through a bus or the like.

The processor 101 is configured by a CPU, a ROM, a RAM, and the like, and constitutes a controller of the HMD. The processor 101 executes a process according to a control program 31 or an application program 32 of the memory 102, thereby realizing functions such as an OS, middleware, and applications and the other functions. The memory 102 is configured by a non-volatile storage device or the like, and stores various kinds of data and information handled by the processor 101 or the like. The control program 31, the application program 32, setting information 33, coordinate system information 34, and display information 35 are stored in the memory 102. The setting information 33 contains system setting information and user setting information. The coordinate system information 34 contains information for managing the coordinate system of the own terminal, and information on amounts (will be described later) and conversion parameter as management information at the time of position recognition sharing with another terminal. The display information 35 contains data for displaying an image such as a virtual object. Further, images and sensor information obtained by the camera 6, the distance measuring sensor 7, the sensor unit 4, or the like are stored in the memory 102 as temporary processing information.

The sensor unit 4 includes, for example, an acceleration sensor 41, a gyro sensor (or an angular rate sensor) 42, a geomagnetism sensor 43, a GPS receiver 44 as various kinds of sensors for detecting a state of the HMD. The sensor unit 4 detects a position, a direction, an attitude (tilt), a motion, and the like of the HMD using the information detected by these sensors. The HMD is not limited to this, and may include an illuminance sensor, a proximity sensor, a barometric pressure sensor, and the like as other sensors.

The communication device 80 includes a communication processing circuit and an antenna corresponding to various kinds of communication interfaces such as a mobile network, Wi-Fi (registered trademark), BlueTooth (registered trademark), and infrared rays. The communication device 80 executes wireless communication processing with the other terminal 1 or the access point 23.

The display device 50 includes a display driving circuit and the display surface 5, and displays an image on the display surface 5 on the basis of image data. Note that the display device 50 is not limited to the transmission type display device, may be a non-transmission type display device or the like. In that case, an image generated corresponding to VR is displayed on the display surface 5.

The camera 6 converts light incident from a lens into an electrical signal by an image pickup device to obtain an image. In a case where a TOF sensor is used as the distance measuring sensor 7, for example, a distance to an object is calculated from a time when light emitted to the outside world hits the object and returns.

The voice input device converts input voice from the microphone 81 into voice data. The voice output device outputs voice from the speaker 82 on the basis of voice data. The voice input device may include a voice recognizing function. The voice output device may include a voice synthesis function.

The operation input unit 83 is a portion that receives an operation input against the HMD such as on/off of power and adjustment of volume, for example, and is configured by a hardware button or a touch sensor. The battery 84 supplies electric power to each component.

### [Controller]

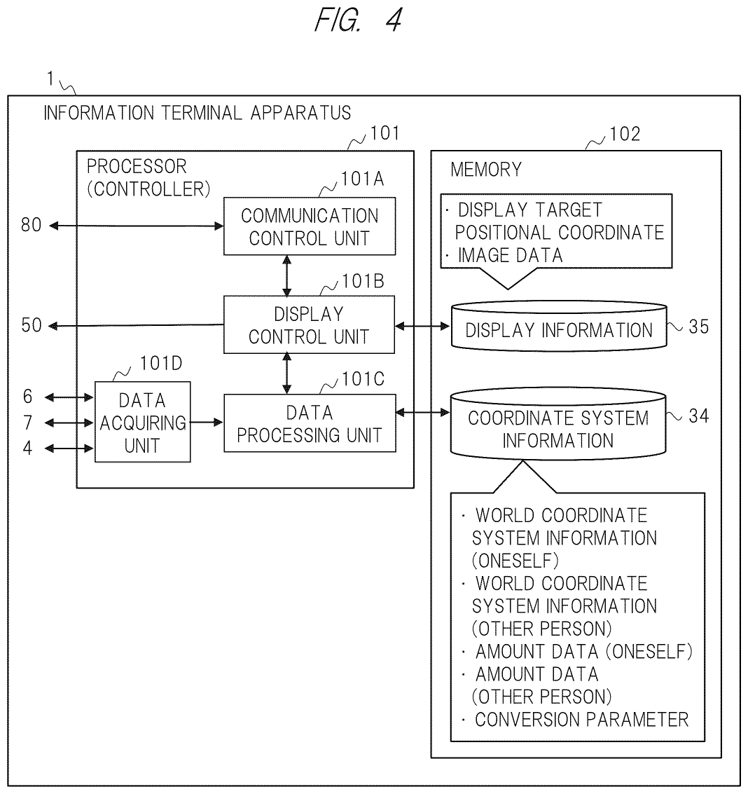

FIG. 4 illustrates an example of a functional block configuration of a controller and the like by the processor the 101 of terminal 1. The controller includes a communication control unit 101A, a display control unit 101B, a data processing unit 101C, and a data acquiring unit 101D as function blocks realized by processes of the processor 101.

The communication control unit 101A controls communication using the communication device 80. The display control unit 101B uses the display information 35 to control display of an image onto the display surface 5 of the display device 50. The display information 35 contains image data of an image of a display target and information such as a display position coordinate.

The data processing unit 101C uses the coordinate system information 34 to execute a process for managing the world coordinate system of the own terminal, a process for coordinate system pairing at the time of position recognition sharing, and a process for conversion between coordinate systems after sharing. At the time of the coordinate system pairing, the data processing unit 101C executes a process of measuring and exchanging amounts between the terminals 1, and a process of generating and setting conversion parameters for the conversion between the coordinate systems. Further, when positions are transmitted between the terminals 1, the data processing unit 101C uses the conversion parameters to execute conversion processing for obtaining a shared position.

The data acquiring unit 101D obtains respective detected data from the sensor unit 4, the camera 6, and the distance measuring sensor 7. The data acquiring unit 101D executes measurement of the amounts at the time of the coordinate system pairing. In a case where conversion is executed using the own terminal as a reference, the coordinate system information 34 contains world coordinate system information of the own terminal, world coordinate system information of the other terminal, amount data of the own terminal, amount data of the other terminal, and the conversion parameters.

### [Sharing of Coordinate System]

FIG. 5 illustrates an explanatory drawing regarding the coordinate systems and the amounts in a case where position recognition sharing in the real space is executed between the two information terminal apparatuses 1 (1A, 1B) illustrated in FIG. 1. Hereinafter, a case where sharing of respective world coordinate systems (WA, WB) fixed in the real space is executed between the two terminals 1 (1A, 1B) will be described with reference to FIG. 5. In the embodiment, a coordinate system that serves as a reference for specifying a position in the real space in each of the terminals 1 (1A, 1B) is a world coordinate system. The coordinate system of the terminal 1A is a world coordinate system WA, and the coordinate system of the terminal 1B is a world coordinate system WB. An origin and a direction of the world coordinate system are fixed in the real space. Since the world coordinate system is set for each terminal 1, these world coordinate systems are basically different coordinate systems, and do not match with each other in an initial state. The world coordinate system WA has an origin O_{A}, an axis X_{A}, an axis Y_{A}, and an axis Z_{A}. The world coordinate system WB has an origin O_{B}, an axis X_{B}, an axis Y_{B}, and an axis Z_{B}. Positions LA, LB of the respective terminals 1 are central positions defined in advance. Even in case of a terminal on which a non-transmission type display is mounted, a display position of a displaying object can be shared with the other terminal while the world coordinate system of the terminal is fixed in the real space.

In the example of FIG. 5, a position of the origin O_{A} of the world coordinate system WA is different from the position LA of the terminal 1A, and a position of the origin O_{B} of the world coordinate system WB is different from the position LB of the terminal 1B. However, it is not limited to this. Hereinafter, a relationship between coordinate systems will be described in a general case where the origin of the world coordinate system does not match with the position of the terminal 1 as illustrated in FIG. 5.

A coordinate value of the position LA of the terminal 1A in the world coordinate system WA is d_{A}=(x_{A}, y_{A}, z_{A}). A coordinate value of the position LB of the terminal 1B in the world coordinate system WB is d_{B}=(x_{B}, y_{B}, z_{B}). These coordinate values are parameters that are determined in accordance with setting of the world coordinate system. A terminal position vector V_{A} is a vector from the origin O_{A} to the position LA. A terminal position vector V_{B} is a vector from the origin O_{B} to the position LB.

### [Coordinate System Pairing and Measurement of Amounts]

In the first embodiment, in a case where each terminal 1 executes position recognition sharing with the other terminal 1, for example, in a case where the same position 21 is shared between the terminal 1A and the terminal 1B as the display target position LG of the same image 22, the respective terminals 1 executes sharing of world coordinate system information of the both. This operation of sharing the world coordinate system information is described as coordinate system pairing. In a case where the coordinate system pairing is executed between the two terminals 1 (1A, 1B) illustrated in FIG. 5, an operation of the coordinate system pairing may be executed once using the two terminals 1 (1A, 1B) as one pair. Even in a case where there are three of more terminals 1, the coordinate system pairing may similarly be executed for each pair.

In the first embodiment, at the time of the coordinate system pairing, the respective terminals 1 (1A, 1B) measure a predetermined amount, and exchange amount data between the terminals 1 (1A, 1B). Namely, the terminal 1A transmits amount data measured in the own world coordinate system WA to the terminal 1B of the other person, and the terminal 1B transmits amount data measured in the own world coordinate system WB to the terminal 1A. Each of the terminals 1 can calculate a relationship of the respective world coordinate systems of the pair, specifically, a conversion parameter for conversion between the coordinate systems on the basis of the amount data. This makes it possible to share the world coordinate system information between the terminals 1 (1A, 1B), and share position recognition.

In the first embodiment, as the amounts at the time of the coordinate system pairing, there are three elements of information below. The amounts have a specific directional vector as first information, an inter-terminal vector as second information, and a world coordinate value as third information.

(1) Specific directional vector: Each of the terminals 1 uses a specific directional vector as information regarding a specific direction in the real space in the own world coordinate system of the corresponding terminal 1. In the first embodiment, in particularly, the specific direction is a vertical downward direction. In the example of FIG. 5, specific directional vectors N_{A}, N_{B} of the vertical downward direction as the specific direction are used. The specific directional vector N_{A} is a directional vector of the terminal 1A in the vertical downward direction, and a unit directional vector is n_{A}. The specific directional vector N_{B} is a directional vector of the terminal 1B in the vertical downward direction, and a unit directional vector is n_{B}.

The vertical downward direction can be measured as a direction of gravitational acceleration by using a 3-axis acceleration sensor, which is the acceleration sensor 41 included in the terminal 1, for example. Alternatively, in the setting of the world coordinate systems WA, WB, the vertical downward direction may be set as a minus direction of the Z axis (Z_{A}, Z_{B}). In any case, since this vertical downward direction that is the specific direction does not change in the world coordinate system, it is not necessary to measure it each time the coordinate system pairing is executed.

(2) Inter-terminal vector: Each of the terminals 1 uses information on vector (that is, a direction and a between terminal positions as information distance) representing a positional relationship from one terminal 1 (for example, the terminal 1A) to the other terminal 1 (for example, the terminal 1B). This information is described as “inter-terminal vector”. In the example of FIG. 5, the inter-terminal vectors P_{BA}, P_{AB} are used. The inter-terminal vector P_{BA} is a vector representing a positional relationship in a direction from the position LA of the terminal 1A to the position LB of the terminal 1B with respect to the terminal 1A. The inter-terminal vector P_{AB} is a vector representing a positional relationship in a direction from the position LB of the terminal 1B to the position LA of the terminal 1A with respect to the terminal 1B. This inter-terminal vector includes information regarding another specific direction in the real space for finding a relationship between orientations of the coordinate systems.

At the time of the coordinate system pairing, each of the terminals 1 measures an inter-terminal vector to the terminal 1 of the other person by using the distance measuring sensor 7 illustrated in FIG. 2, for example. Vector representation from the terminal 1A to the terminal 1B in the world coordinate system WA is P_{BA}, and vector representation from the terminal 1B to the terminal 1A in the world coordinate system WB is P_{AB}. Note that distance measurement of the positional relationship between the terminals 1 may be as follows in detail. For example, the distance measuring sensor 7 of the terminal 1A measures a distance to the terminal 1B that is viewed in front. At this time, the terminal 1A may measure a shape of the chassis of the terminal 1B as a camera image, or may measure a marker or the like formed on the chassis of the terminal 1B as a feature point.

(3) World coordinate value: The respective terminals 1 use information on coordinate values respecting positions of the terminals 1 in the world coordinate systems. In the example of FIG. 5, the coordinate value d_{A} of the world coordinate system WA and the coordinate value d_{B} of the world coordinate system WB are used as the world coordinate values.

In FIG. 5, a vector FA is a vector representing a position of the other terminal 1B in the world coordinate system WA of the own terminal (the terminal 1A), which corresponds terminal information, and to position corresponds to a vector obtained by synthesizing the coordinate value d_{A} of the own terminal (the vector V_{A}) and inter-terminal vector P_{BA}. A vector F_{B} is a vector representing a position of the other terminal 1A in the world coordinate system WB of the own terminal (the terminal 1B), and corresponds to a vector obtained by synthesizing the coordinate value d_{B} of the other terminal (the vector V_{B}) and the inter-terminal vector P_{AB}.

At the time of the coordinate system pairing, the terminal 1A measures the specific directional vector N_{A}, the inter-terminal vector P_{BA}, and the coordinate value d_{A} as amount data 501 of the own terminal side, and transmits these amount data 501 to the terminal 1B. The terminal 1B measures the specific directional vector N_{B}, the inter-terminal vector P_{AB}, and the coordinate value d_{B} as amount data 502 of the own terminal side, and transmits these amount data 502 to the terminal 1A.

Note that, in a case where only the terminal 1A grasps the relationship of the coordinate systems to execute conversion between the coordinate systems, the terminal 1A may obtain the amount data 501 of the own terminal and the amount data 502 from the terminal 1B, and it is not necessary to transmit the amount data 501 from the terminal 1A to the terminal 1B. On the contrary, in a case where only the terminal 1B executes conversion, it is not necessary to transmit the amount data 502 from the terminal 1B to the terminal 1A.

### [Conversion Parameter]

By the coordinate system pairing described above, the relationship of the world coordinate systems WA, WB between the terminals 1 (1A, 1B) can be understood, and the conversion between the world coordinate systems WA, WB becomes possible. Namely, conversion for matching the world coordinate system WB to the world coordinate system WA or its reverse conversion becomes possible. The conversion between the world coordinate systems is represented by a predetermined conversion parameter. The conversion parameter is a parameter for calculation of conversion of a direction of a coordinate system (in other words, rotation) and a difference of origins of coordinate systems.

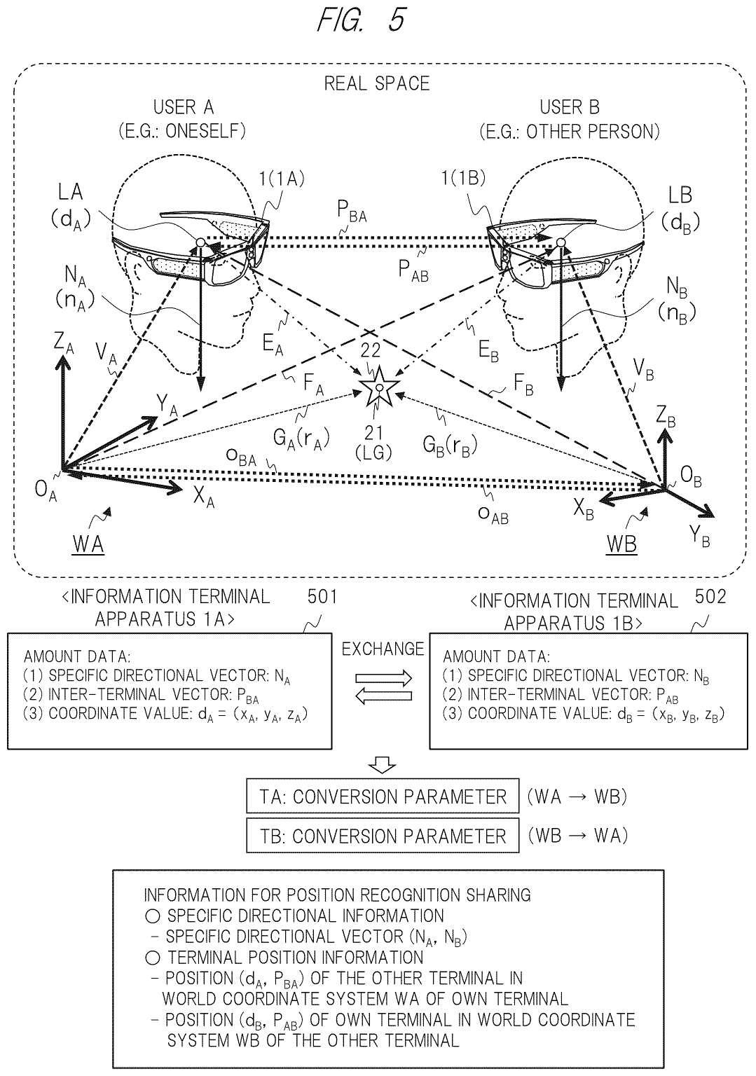

FIG. 6 illustrates each example of conversion at the time of transmission of a position between the terminals 1 and an example of the conversion parameters. For example, in a case where the terminal 1A executes conversion between the coordinate systems in the own terminal, the amount data 501, 502 of both the own terminal and the terminal 1B of the other person are obtained, and a relationship between the world coordinate systems WA, WB is calculated from the amount data 501, 502. Specifically, as illustrated in FIG.

6, the terminal 1A generates and holds a conversion parameter TA for conversion. A position on the world coordinate system WB is obtained by conversion using the conversion parameter TA from a position on the world coordinate system WA. Similarly, in a case where the terminal 1B executes conversion between the coordinate systems in the own terminal, the terminal 1B generates and holds a conversion parameter TB for conversion between the world coordinate systems WA, WB from both the amount data 501, 502.

Between the terminals 1 (1A, 1B) after position recognition sharing by the coordinate system pairing, it is possible to specify the same position 21 in the real space. The one terminal 1 transmits information on the specified position 21 to the other terminal 1. The one terminal 1 or the other terminal 1 executes conversion between the coordinate systems regarding the position 21.

In FIG. 5, a position vector G_{A} is a vector of the position 21 of the image 22 in the world coordinate system WA, and a positional coordinate value r_{A} is a coordinate value of the position 21. A position vector G_{B} is a vector of the position 21 in the world coordinate system WB, and a positional coordinate value r_{B} is a coordinate value of the position 21. An origin-to-origin vector O_{BA} is a vector from the origin O_{A} to the origin O_{B} (representation of the origin O_{B} in the world coordinate system WA), and an origin-to-origin vector o_{AB} is a vector from the origin O_{B} to the origin O_{A} (representation of the origin O_{A} in the world coordinate system WB).

The conversion of the positions may be executed by the terminal 1A using the conversion parameter TA, or may be executed by the terminal 1B using the conversion parameter TB. One of the terminal 1A and the terminal 1B may hold the conversion parameters, or both thereof may hold the conversion parameters.

(A) of FIG. 6 is a first example regarding transmission. For example, the terminal 1A transmits position information such as the display target position LG of the image 22 to the terminal 1B. At that time, the terminal 1A obtains the positional coordinate value r_{B} on the world coordinate system WB from the positional coordinate value r_{A} on the world coordinate system WA by conversion based on the conversion parameter TA, and transmits it to the terminal 1B. (B) is a second example. The terminal 1A transmits the positional coordinate value r_{A} on the world coordinate system WA to the terminal 1B. The terminal 1B obtains the positional coordinate value r_{B} on the world coordinate system WB from the positional coordinate value r_{A} by conversion based on the conversion parameter TB. (C) is a third example. The terminal 1B obtains the positional coordinate value r_{A} on the world coordinate system WA from the positional coordinate value r_{B} on the world coordinate system WB by conversion based on the conversion parameter TB, and transmits it to the terminal 1A. (D) is a fourth example. The terminal 1B transmits the positional coordinate value r_{B} on the world coordinate system WB to the terminal 1A. The terminal 1A obtains the positional coordinate value r_{A} on the world coordinate system WA from the positional coordinate value r_{B} by conversion based on the conversion parameter TA.

In FIG. 6, for example, a table of the conversion parameters has information on an ID of the other terminal (the other user), information on representation of rotation between the coordinate systems, and information on representation of an origin between the coordinate systems. For example, the table for the conversion parameter TA possessed by the terminal 1A has an ID of the other terminal 1B (the other user B), representation (q_{AB}) of rotation for matching with the world coordinate system WB of the other person, and representation (o_{BA}) of the origin of the world coordinate system WB when viewed from the world coordinate system WA.

In FIG. 5, each user of each terminal 1 can visually recognize the image 22 displayed at the same position 21 in the real space commonly. A vector E_{A} is a vector in a case where the image 22 at the position 21 is viewed from the position LA of the terminal 1A, which corresponds to a viewpoint of the user A. A vector E_{B} is a vector in a case where the image 22 at the position 21 is viewed from the position LB of the terminal 1B, which corresponds to a viewpoint of the user B.

### [Image Display Example]

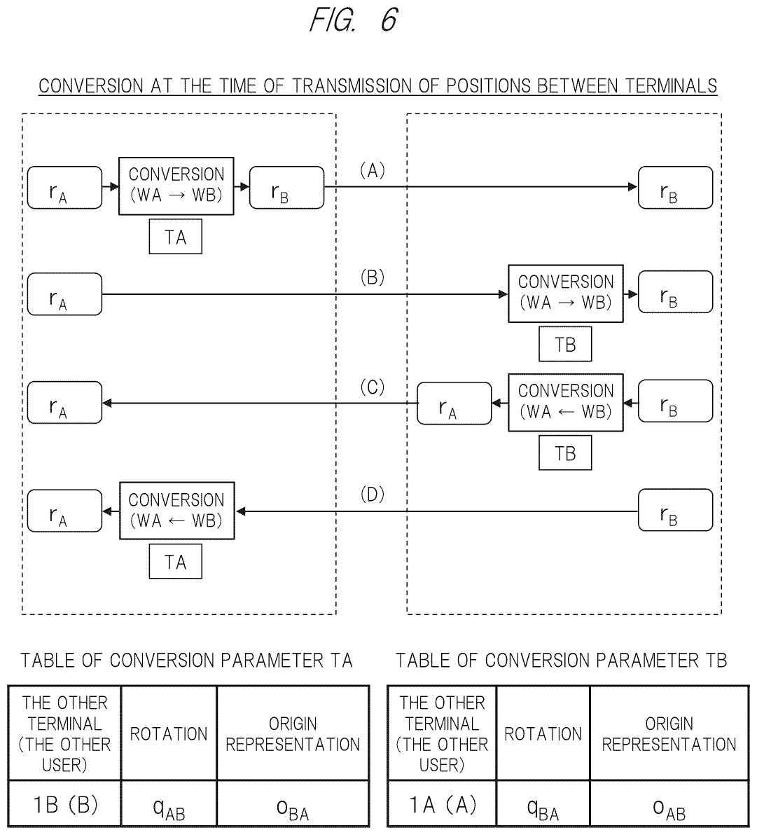

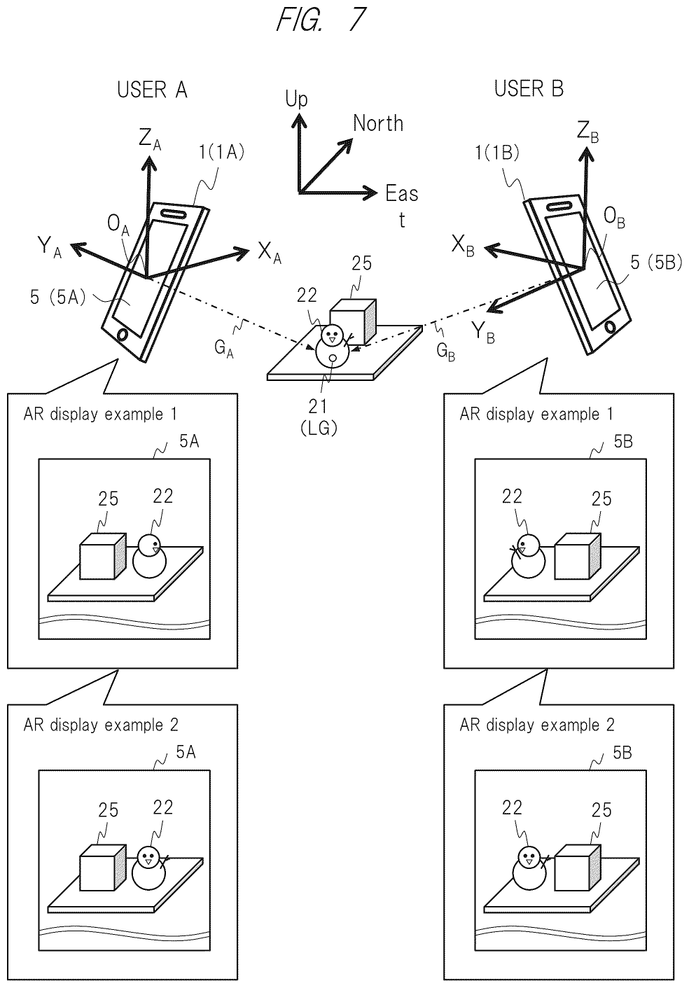

FIG. 7 illustrates an example in which the image 22 of the same virtual object of AR is displayed at the display target position LG, which is the same position 21 subjected to the position recognition sharing between the terminals 1 (1A, 1B) after the coordinate system pairing in a case where the information terminal apparatus 1 is a smartphone. Further, the present example illustrates a case where the positions of the respective terminals 1 are the same as the origins of the respective world coordinate systems. After the coordinate system pairing, a certain position 21 in the real space is specified as the display target position LG of the virtual object.

The AR image 22 is superimposed on a real object 25 and displayed on a display surface 5A of the terminal 1A of the user A. Similarly, the AR image 22 is superimposed on the real object 25 and displayed on a display surface 5B of the terminal 1B of the user B. In the present embodiment, a case where orientation of arrangement is set to the image 22 is illustrated. For example, in an AR display example 1, the image 22 is arranged at the position 21 in a state where a front face of the image 22 faces south. The appearance of the image 22 from each terminal 1 differs depending upon a positional relationship with the image 22. The image 22 at the position 21 is captured in a state where it faces to the right on the display surface 5A of the terminal 1A. The image 22 at the position 21 is captured in a state where it faces to the left on the display surface 5B of the terminal 1B.

Another example (AR display example 2) is also illustrated in FIG. 7. This example illustrates a case where the same image 22 is controlled so as to be viewed from each terminal 1. The image 22 at the position 21 is captured in a state where it faces the terminal 1 of the user on both the display surface 5A of the terminal 1A and the display surface 5B of the terminal 1B.

Note that when the position is transmitted and the image 22 is displayed after the position recognition sharing described above, a method of transmitting the position and the image data from the one terminal 1 to the other terminal 1 for each display of the image 22 may be adopted, or another method may be adopted. For example, the terminal 1A transmits a positional coordinate and image data to the terminal 1B, and the terminal 1B immediately displays the image 22 at the specified position 21 on the display surface 5 in accordance with them. Alternatively, the terminal 1B may give priority to a process of an application in the own terminal, and postpone or reject display of the image at the shared position. As a modification example, it may be a form in which authority for controlling display of the image at the shared position is provided and authority for image display control of the other terminal 1 is passed to the one terminal 1. For example, during the position recognition sharing by the coordinate system pairing, the terminal 1B passes the authority to the terminal 1A. The authorized terminal 1A controls not only the own terminal but also the image display of the terminal 1B of the other person. The terminal 1A creates data for controlling the image display in the terminal 1B, and transmits it to the terminal 1B. The terminal 1B displays the image on the display surface 5 in accordance with the received data.

### [Control Flow]

FIG. 8 illustrates a control flow in the information terminal apparatus 1 according to the first embodiment. The flow of FIG. 8 is a control flow in a case where the position recognition sharing is executed between the terminal 1A and the terminal 1B, and has Steps S1A to S9A at the terminal 1A side and corresponding Steps S1B to S9B at the terminal 1B side. In this control flow, at the time of coordinate system pairing, the respective terminals 1 to be paired execute measurement of amounts at a certain timing at almost the same time.

First, at Steps S1A, S1B, the terminals 1A, 1B establish communication between the terminals 1 using a predetermined wireless communication method. Note that the communication may be via the access point 23, or may be direct communication between the terminals 1. At Step S2A, for example, a request for coordinate system pairing is transmitted from the terminal 1A to the terminal 1B. In the present example, the terminal 1A is a request side, but the same applies a case where the terminal 1B is a request side. At Step S2B, the terminal 1B receives the request for the coordinate system pairing from the terminal 1A, confirms whether the coordinate system pairing is agreed or not, and executes a response to the terminal 1A. In a case where it is agreed, the terminal 1B transmits a response of agreement to the terminal 1A. Note that, in a case where it is desired to enhance security at the time of the coordinate system pairing, the terminal 1B may request the terminal 1A to input a passcode or the like set in advance. Further, the request for the coordinate system pairing may be made using an instruction operation from the user as a trigger, or may be made at a trigger automatically determined by the terminal 1.

On the basis of the agreement described above, an operation of the coordinate system pairing is started between the terminals 1 (1A, 1B) after Steps S3A, S3B. First, at Steps S3A, S3B, the respective terminals 1 measure amount data as illustrated in FIG. 5. Namely, for example, the terminal 1A obtains a specific directional vector N_{A}, an inter-terminal vector P_{BA}, and a coordinate value d_{A}.

Note that it is preferable that during the operation of the coordinate system pairing, both the terminals 1 measure the amounts at the same timing as much as possible and in a stationary state as much as possible. Therefore, for example, at the time of the operation of the coordinate system pairing, as will be described later, the respective terminals 1 execute a control of adjusting timing of measurement while outputting a predetermined guide for the coordinate system pairing to the users.

The specific directional vectors (NA, NB) may be measured for each coordinate system pairing, or may be substituted with setting values in a case where there are the setting values that have already been measured and held before the coordinate system pairing and after setting of a world coordinate system. In a case where a Z axis of the world coordinate system is set so as to be in a vertical direction, the vertical direction is not a measured value, but becomes a setting value. However, the setting value may be used as the specific directional vector. A specific direction in the real space may be determined in advance by a convention, or may be determined for each coordinate system pairing.

Next, at Steps S4A, S4B, each terminal 1 transmits the measured amount t data described above {(1) specific directional vector, (2) inter-terminal vector, and (3) coordinate value} to the terminal 1 of the other person to exchange the amount data. Namely, the terminal 1A transmits the amount data 501 illustrated in FIG. 5 to the terminal 1B, and the terminal 1B transmits the amount data 502 to the terminal 1A. Note that, in a case where only one terminal 1, for example, only the terminal 1A grasps the relationship of the coordinate systems and executes the conversion, it is sufficient to only transmit the amount data from the terminal 1B to the terminal 1A.

Next, at Steps S5A, S5B, after each terminal receives the amount data from the terminal 1 of the other person, the terminal 1 sets conversion parameters for conversion of the world coordinate system of the own terminal. The terminal 1A sets the conversion parameter TA illustrated in FIG. 6, and the terminal 1B sets the conversion parameter TB. The coordinate system pairing described above allows the terminals 1 to convert positional coordinates each other between the world coordinate systems thereof. For example, it is possible to convert a positional coordinate value r_{A} viewed from the terminal 1A into a positional coordinate value r_{B} viewed from the terminal 1B.

At Steps S6A, S6B, the one or the other terminal 1, for example, the terminal 1A transmits information on a position to be shared and data such as image data for displaying the position to the terminal 1 of the other person, for example, the terminal 1B. At that time, as illustrated in FIG. 6, the one or the other terminal 1 appropriately executes conversion of the position using the conversion parameters.

At Steps S7A, S7B, the terminal 1 displays an image at a position in the display surface 5 corresponding to the shared position thus specified on the basis of the position and the image data, which are received from the terminal 1 of the other person. This makes it possible for both the terminals 1 to display the image 22 such as a virtual object at the same position 21 in the real space, and realize communication or the like via the image 22.

At Steps S8A, S8B, each terminal 1 confirms whether the position recognition sharing by the coordinate system pairing is to be terminated or not. For example, the termination may be triggered by an instruction input of the user, or may be triggered by automatic determination of the terminal 1. For example, termination confirmation for the user may be executed in a case where a certain time or more has elapsed from the start of the coordinate system pairing. In a case where it is not to be terminated, the processing flow returns to Steps S6A, S6B to repeat the same processes. In a case where it is to be terminated, at Steps S9A, S9B, the terminals 1 execute communication for cancelling the coordinate system pairing therebetween. A method of automatically cancelling the coordinate system pairing after a certain time has elapsed from the start thereof may be adopted.

### [Output Example at Time of Coordinate System Pairing]

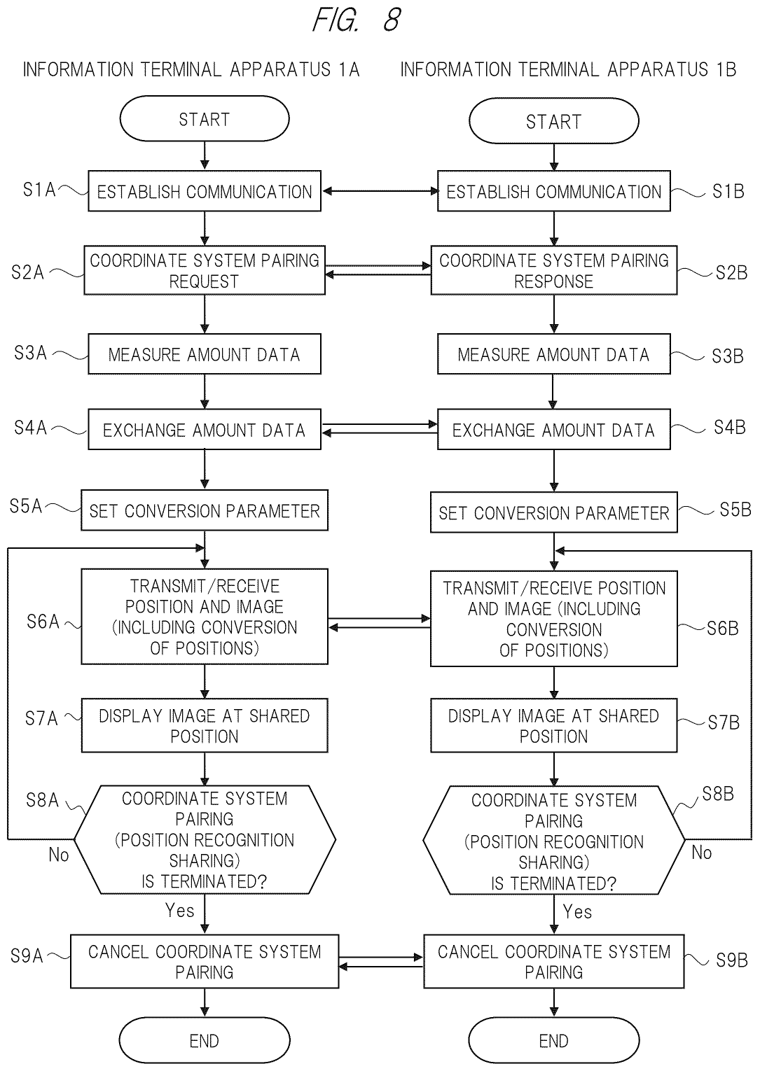

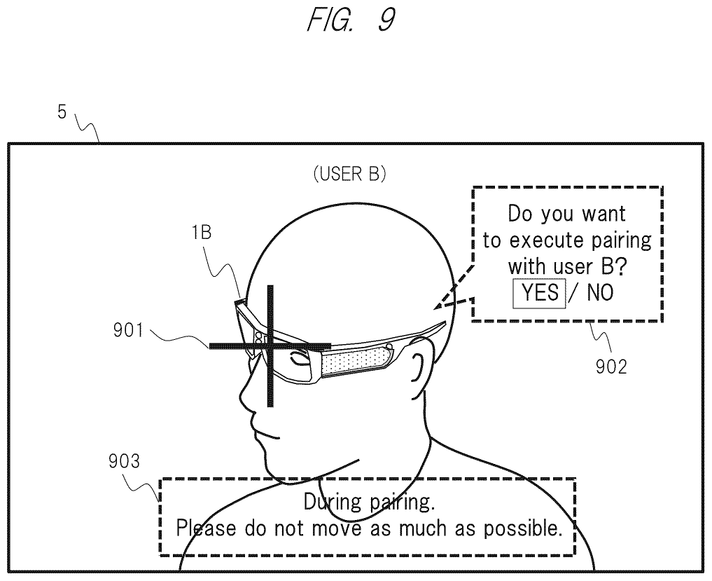

FIG. 9 illustrates an output example corresponding to the display surface 5 at the time of the coordinate system pairing. FIG. 9 illustrates an example in which, for example, when the terminal 1A of the user A executes coordinate system pairing with the terminal 1B of the user B, an image such as a guide is displayed on the display surface 5 of the terminal 1A. The user B and the terminal 1B are visible on the display surface 5. First, at the time of start of the coordinate system pairing, the terminal 1A displays a cursor 901 on the display surface 5 so as to align with a position of the terminal 1B of the other person when viewed from the own terminal. The cursor 901 is a pointing object image. The terminal 1 can detect the terminal 1 of the other person from analysis of an image of the camera 6, for example. Further, in a case where a plurality of terminals 1 of a plurality of users is visible on the display surface 5, the terminal 1A may display cursors, which represent candidates of the coordinate system pairing, at positions of the terminals 1.

The terminal 1A displays a guide image 902 for the terminal 1B at which the cursor 901 is placed. The guide image 902 is an image having information for confirming with the user A whether to execute coordinate system pairing with the terminal 1B of the user B or not. In a case where the user A executes the coordinate system pairing with the terminal 1B of the user B in accordance with the guide image 902, the user A carries out an instruction input of that effect. In accordance with the instruction input, the terminal 1A starts an operation (measurement and the like) of the coordinate system pairing with the terminal 1B.

Further, during the coordinate system pairing operation, in particular, at the time of measurement of an inter-terminal vector, the terminal 1A displays the cursor 901 on the display surface 5 so as to align with the position of the terminal 1B of the other person when viewed from the own terminal, and displays a guide image 903. The guide image 903 is an image that tells the user A that the measurement is being executed and the user A should be stationary as much as possible. If the user and the terminal 1 move during the measurement, a measurement error may occur. For that reason, each terminal 1 outputs the guide image 903 so that the user and the terminal 1 are caused to be stationary as possible during the measurement.

When the measurement is completed, the terminal 1A may display a guide image for indicating that the measurement is completed. Further, the terminal 1A may display an image representing a state of being shared after the coordinate system pairing is established. Similarly, a corresponding guide image is displayed on the terminal 1B side of the other person. As another method, the terminal 1A may automatically execute the coordinate system pairing under a condition that the terminal 1B of the other person is visible on the display surface 5 for a certain time or more, for example. Even in that case, the terminal 1A displays a guide image for that effect on the display surface 5. Further, the terminal 1 is not limited to the image display, and may output a guide by voice or the like.

Note that in calculating the relationship of the coordinate systems, it is necessary that the specific direction (for example, NA) illustrated in FIG. 5 is different from the direction of the inter-terminal vector (for example, PBA). For that reason, if those directions overlap in the same direction, the terminal 1 may output a guide to the user to change the position and then execute the coordinate system pairing again. Since it is rare that the terminals 1 overlap in the vertical upward and downward directions, it is better to select a vertical downward direction as the specific direction in order to avoid the overlap of the directions as described above.

### [Coordinate Conversion (1)]

Hereinafter, details of coordinate conversion will supplementarily be described. First, the notation for explaining a relationship 4 coordinate systems is summarized. In the embodiment, the coordinate system is unified to a right-handed system. In the embodiment, a normalized quaternion is used to represent rotation of the coordinate system. The normalized quaternion is a quaternion with a norm of 1, and can represent rotation around an axis. A normalized quaternion q representing rotation of an angle n using a unit vector (n_{X}, n_{Y}, n_{Z}) as a rotation axis becomes Formula 1 below. Each of i, j, and k is a quaternion unit. Clockwise rotation when oriented in a direction of the unit vector (n_{X}, n_{Y}, n_{Z}) is a positive rotation direction of η. The rotation of an arbitrary coordinate system can be represented by such a normalized quaternion.

$$q = cos ( η / 2 ) + {n}_{X} sin ( r / 2 ) i + {n}_{Y} sin ( η / 2 ) j + {n}_{Z} sin ( η / 2 ) k \qquad Formula 1$$

A real part of the quaternion q is represented by Sc(q). A conjugate quaternion of the quaternion q is represented by q*. An operator that normalizes a norm of the quaternion q to 1 is defined by [·]. Assuming that the quaternion q is an arbitrary quaternion, Formula 2 is the definition of [·]. A denominator of the right side of Formula 2 is the norm of the quaternion q.

$$[ q ] = q / {( q {q}^{⋆} )}^{1 / 2} \qquad Formula 2$$

Next, a quaternion p that represents a coordinate point or a vector (p_{X}, p_{Y}, p_{Z}) is defined by Formula 3.

$$p = {p}_{X} i + {p}_{Y} j + {p}_{Z} k \qquad Formula 3$$

In the present specification, unless otherwise specified, symbols representing coordinates point and vectors that are not in component form are quaternion representation. Further, symbols representing rotation are normalized quaternions.

A projection operator of a vector on a plane perpendicular to a direction of a unit vector n is represented by P_{T}(n). Projection of a vector p is represented by Formula 4.

$${P}_{T} ( n ) p = p + nSc ( np ) \qquad Formula 4$$

Assuming that a coordinate point or a directional vector p₁ is converted into a coordinate point or a directional vector p₂ by a rotational operation of the center of the origin represented by the quaternion q, the directional vector p₂ can be calculated by Formula 5.

$${p}_{2} = {qp}_{1} {q}^{⋆} \qquad Formula 5$$

A normalized quaternion R(n₁, n₂) that cause the unit vector n₁ to rotate around an axis perpendicular to a plane that includes the unit vector n₁ and the unit vector n₂ so that the unit vector n₁ is superimposed on the unit vector n₂ becomes Formula 6 below.

$$R ( {n}_{1} , {n}_{2} ) = [ 1 - {n}_{2} {n}_{1} ] \qquad Formula 6$$

### [Coordinate Conversion (2)]

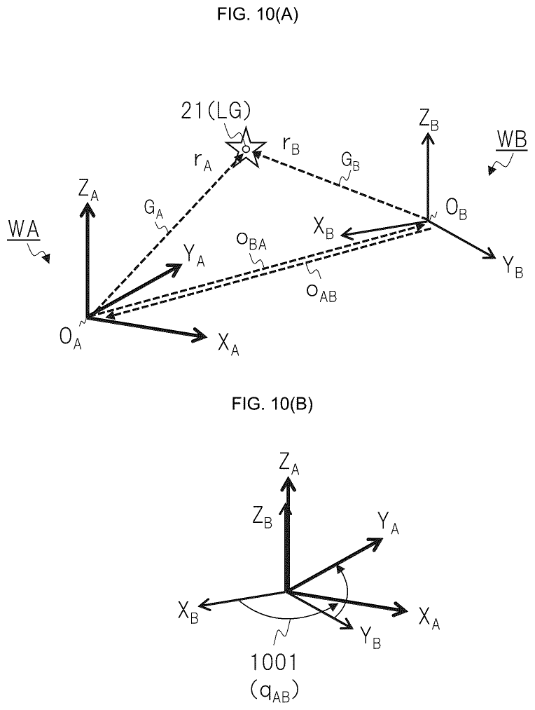

FIGS. 10(A)-10(B) illustrate an explanatory drawing about conversion of a coordinate system. In the similar manner to that of FIG. 5, FIG. 10(A) illustrates representation regarding the same position 21 (the display target position LG) in the real space and representation of a difference between coordinate origins (O_{A}, O_{B}) between the world coordinate system WA and the world coordinate system WB. As the representation of the position 21, there are a position vector G_{A}, a positional coordinate value r_{A}, a position vector G_{B}, and a positional coordinate value r_{B}. As the representation of the difference between the coordinate origins, there are origin-to-origin vectors o_{BA}, o_{AB}. The origin-to-origin vector o_{BA} is representation of the origin O_{B} in the world coordinate system WA. The origin-to-origin vector o_{AB} is representation of the origin O_{A} in the world coordinate system WB.

Representations (N_{A}, N_{B}, P_{BA}, P_{AB}) in the respective world coordinate systems WA, WB about two different specific directions (a specific directional vector and an inter-terminal vector) in the real space are obtained on the basis of the amounts described above (FIG. 5). This makes it possible to obtain a rotational operation between the coordinate systems so as to match those representations by the operation using the normalized quaternion described above. Therefore, by combining these kinds of information with the information of each of the coordinate origins, it becomes possible to convert the positional coordinates between the coordinate systems.

A relationship between the world coordinate systems WA, WB can be calculated as follows. Hereinafter, a calculation for obtaining a difference between the rotation and the coordinate origin in a case where representations of a coordinate value and a vector value in the world coordinate system WB of the terminal 1B are converted into representations in the world coordinate system WA of the terminal 1A will be described.

FIG. 10(B) illustrates an operation of rotation for aligning directions between the world coordinate system WA and the world coordinate system WB, for example, simply illustrates an image of rotation 1001 (rotation q_{AB}) for aligning directions of the respective axes (X_{B}, Y_{B}, Z_{B}) of the world coordinate system WB with directions the axes (X_{A}, Y_{A}, Z_{A}) of the world coordinate system WA.

First, rotation for aligning the directions of the world coordinate system WA with the directions of the world coordinate system WB is obtained. Unit directional vectors m_{A}, m_{B} between the terminals are defined on the basis of the inter-terminal vectors P_{BA}, P_{AB} described above. The unit directional vectors m_{A}, m_{B} are respectively representation in the world coordinate system WA and representation in the world coordinate system WB about a unit vector in a direction from the terminal 1A toward the terminal 1B in the real space.

$${m}_{A} = [ {P}_{BA} ]$$

$${m}_{B} = [ - {P}_{AB} ]$$

First, in rotation in representation of the world coordinate system WA, rotation q_{T1} in which a unit vector n_{A} in a specific direction is superimposed on a unit vector n_{B} is considered. Specifically, the rotation q_{T1} is as follows.

q_{T1}=R(n_{A}, n_{B})

Next, directions obtained from the specific directional unit vectors n_{A} and m_{A} by this rotation q_{T1} are respectively defined as n_{A1} and m_{A1}.

$${n}_{A 1} = {q}_{T 1} {n}_{A} {q}_{T 1} *= {n}_{B}$$

$${m}_{A 1} = {q}_{T 1} {m}_{A} {q}_{T 1} *$$

Since it is an angle between the same directions in the real space, an angle formed by a direction n_{A1} and a direction m_{A1} is equal to an angle formed by the unit vector n_{B} and a unit directional vector m_{B}. Further, the two specific directions are different directions as a premise, the angle formed by the unit vector n_{B} and the unit directional vector m_{B} is not zero. Therefore, by using the direction n_{A1}, that is, the unit vector n_{B} as an axis, it is possible to constitute rotation q_{T2} so as to superimpose the direction m_{A1} on the unit directional vector m_{B}. Specifically, the rotation q_{T2} is given below.

q_{T2}=R([P_{T}(n_{B})m_{A1}], [P_{T}(n_{B})m_{B}])

Since the direction n_{A1} is the same direction as a rotation axis direction n_{B} of the rotation q_{T2}, it remains unchanged due to this rotation q_{T2}. Further, the direction m_{A1} is rotated to the unit directional vector m_{B} by this rotation q_{T2}.

n_{B}=q_{T2}n_{A1}q_{T2}*

m_{B}=q_{T2}m_{A1}q_{T2}*

Rotation q_{BA} is newly defined below.

q_{BA}=q_{T2}q_{T1}

The unit vector n_{A} and a unit directional vector m_{A} are respectively rotated to the unit vector n_{B} and the unit directional vector m_{B} by this rotation q_{BA}.

n_{B}=q_{BA}n_{A}q_{BA}*

m_{B}=q_{BA}m_{A}q_{BA}

Since the unit vector n_{A} and the unit directional vector m_{A} are selected as two different directions, this rotation q_{BA} is rotation by which directional representation in the world coordinate system WA is converted into directional representation of the world coordinate system WB. On the contrary, if rotation by which the directional representation in the world coordinate system WB is converted into the directional representation in the world coordinate system WA is the rotation q_{AB}, the rotation q_{AB} is similarly as follows.

q_{AB}=q_{BA}*

Next, a conversion formula of the coordinate values d_{A}, d_{B} (FIG. 5) is obtained. The coordinate values d_{A}, d_{B} herein are quaternion representations of coordinate values defined by Formula 3. First, a coordinate value of an origin of the other coordinate system when viewed from one coordinate system is obtained. As illustrated in FIG. 10(A), representation of the coordinate value of the origin O_{B} in the world coordinate system WB with respect to the world coordinate system WA is o_{BA}, and representation of the coordinate value of in the origin O_{A} the world coordinate system WA with respect to the world coordinate system WB is o_{AB}. Since the coordinate values d_{A}, d_{B} of the positions of the terminal 1 in the respective coordinate systems are known, origin coordinate value representations (o_{BA}, o_{AB}) can be obtained by Formulas A below.

$${o}_{BA} = {d}_{A} + {P}_{BA} - {q}_{AB} {d}_{B} {q}_{AB}^{⋆} \qquad Formulas A$$

$${o}_{AB} = {d}_{B} + {P}_{AB} - {q}_{BA} {d}_{A} {q}_{BA}^{⋆}$$

Further, as can be seen easily, there is a relationship below.

o_{AB}=−q_{BA}o_{BA}q_{BA}*

Finally, conversion formulas of the coordinate value r_{A} in the world coordinate system WA and the coordinate value r_{B} in the world coordinate system WB of an arbitrary point (the position 21) in the real space are given as follows.

$${r}_{B} = {q}_{BA} ( {r}_{A} - {o}_{BA} ) {q}_{BA}^{⋆} = {q}_{BA} {r}_{A} {q}_{BA}^{⋆} + {o}_{AB}$$

$${r}_{A} = {q}_{AB} ( {r}_{B} - {o}_{AB} ) {q}_{AB}^{⋆} = {q}_{AB} {r}_{B} {q}_{AB}^{⋆} + {o}_{BA}$$

As described above, for example, in a case where it is desired to convert the specific position 21 (the coordinate value r_{A}) when viewed in the world coordinate system WA of the terminal 1A into the position 21 (the coordinate value r_{B}) when viewed from the terminal 1B, it can be calculated using the rotation q_{BA}, the coordinate value r_{A}, and origin representation o_{AB}. The reverse conversion can also be calculated in the similar manner. The conversion parameters TA and TB described above illustrated in FIG. 6 can be configured by the parameters (the rotation and the origin representation) introduced in the description of the conversion of the coordinate systems described above. Note that since it can be converted easily, the q_{BA} may be held instead of the q_{AB} and the o_{AB} may be held instead of the OBA, or the reverse is also possible.

### [Application Example (1)]

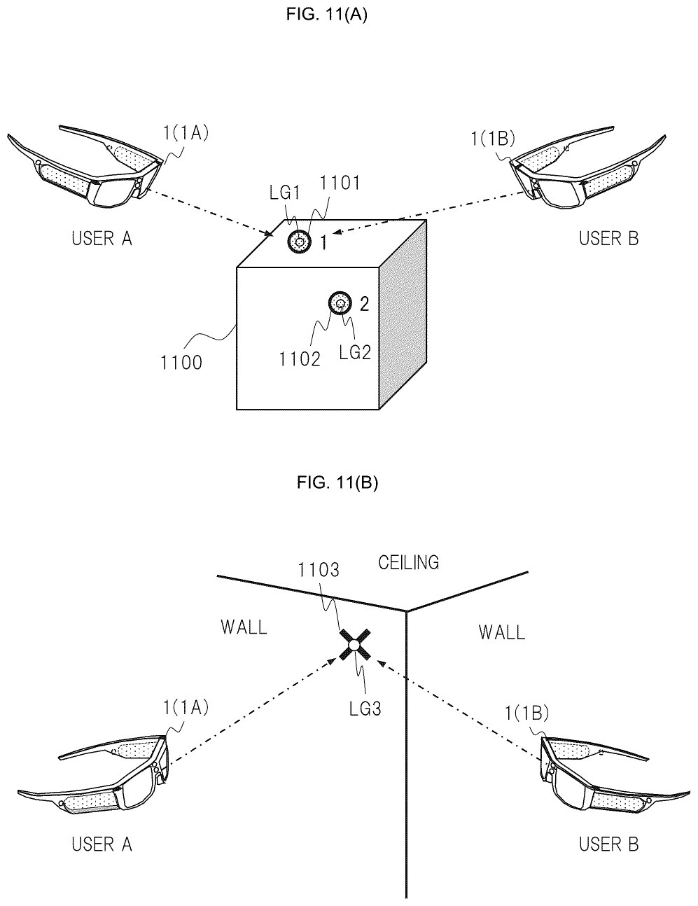

As an application example of position specification and image display by the position recognition sharing, the following is also possible. FIGS. 11(A)-11(B) illustrate an application example in which an image of a virtual object such as a pointing object for pointing a position in a real space or a corresponding real object is displayed between terminals 1 in a position recognition sharing state. FIG. 11(A) illustrates a first example, and FIG. 11(B) illustrates a second example. In FIG. 11(A), for example, a terminal 1A of a user A is in a position recognition sharing state after coordinate system pairing with a terminal 1B of another user B. For example, the user A specifies an arbitrary position within a field of view, which the user A want to specify, for example, a position LG1 in a work object 1100. The specification can be made by a predetermined input operation against the terminal 1A (for example, an operation to an operating device 3). In response to a specification operation of the user A, the terminal 1A displays a pointing object image 1101 at the position LG1 on the display surface 5. Further, the terminal 1A transmits information such as the specified position LG1 to the terminal 1B. The terminal 1B displays the similar pointing object image 1101 at the same position LG1 when viewed from the terminal 1B on the basis of the information from the terminal 1A. The pointing object image 1101 according to the present example is an image of a dot with a number, but is not limited to this. Various kinds of images can be applied. Similarly, the user A or the user B can cause a pointing object image 1102 to be displayed at another arbitrary specified position LG2. Thus, even in a case where the work object 1100 has a complicated shape or is an object that cannot be touched by a hand, the user A and the user B share and recognize the same position via the pointing object, whereby efficient work and the like are possible.

In FIG. 11(B), for example, the terminal 1A of the user A specifies a position LG3 on a wall surface near ceiling in a building. The terminal 1A displays a pointing object image 1103 at the position LG3. Further, the terminal 1B of the user B displays the pointing object image 1103 at the same position LG3. The pointing object image 1103 according to the present example is an image marked with ×. Thus, even in a case where a position is out of reach from a user, it is possible to share and recognize the same position via the pointing object between the users.

### [Application Example (2)]

In this position recognition sharing system, it is not essential to display an image at a specified position, and it is also possible to simply use transmission of a position between terminals 1. A terminal 1 on the side where a position is transmitted from a terminal 1 of another person can made an arbitrary application using information on the position.

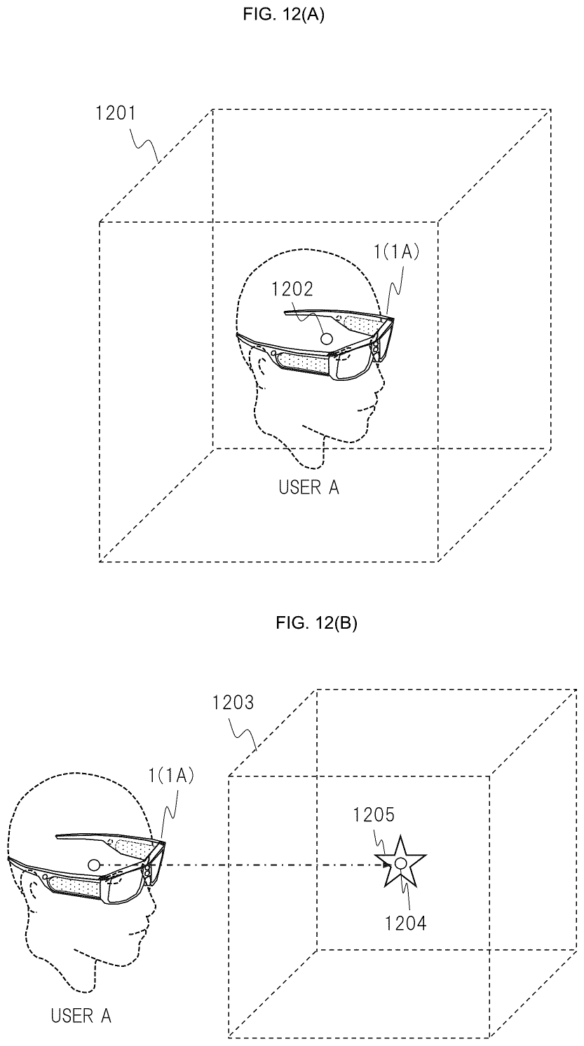

FIGS. 12(A)-12(B) illustrate an application example of transmission of a position. FIG. 12(A) illustrates a first example, and FIG. 12(B) illustrates a second example. In FIG. 12(A), for example, a terminal 1A of a user A carries out an operation of specifying an arbitrary domain 1201 in the vicinity of the user A in a real space after coordinate system pairing with another user B. This domain 1201 is a two-dimensional or three-dimensional domain formed by a gathering of positions, and in the present example, it is a three-dimensional cubic domain centered on a position 1202 of the terminal 1A. The terminal 1A transmits information on this domain 1201 to the terminal 1B of the user B. This domain 1201 is a domain for the user A to temporarily secure a range of movement of his or her body and an HMD, for example. In accordance with the information on this domain 1201, the terminal 1B outputs attention to the user B by display or voice so that the user B and the terminal 1B do not enter the domain 1201. An image of lines representing the domain 1201 may be displayed on a display surface 5 of each of the terminal 1A and the terminal 1B. The user B is careful not to enter the domain 1201. This makes it possible to prevent body contact between the users, whereby the user A can easily work in the domain 1201. For example, the domain 1201 may be defined by the central position 1202 and widths, or may be defined by positions of the vertexes constituting the domain 1201, or may further be selected from sizes or shapes set in advance.

In FIG. 12(B), for example, the terminal 1A of the user A carries out an operation of specifying a domain 1203 in front of himself or herself, and the terminal 1A transmits information on the domain 1203 to the terminal 1B of the user B. This domain 1203 does not include the position of the terminal 1A, and is a domain for temporarily securing a range in which the user A wants the terminal 1A to display an image of a virtual object, for example. For example, authority that the terminal 1A of the user A can preferentially display a shared image in this domain 1203 is set thereto. The terminal 1A displays a shared image 1205 at a specified position 1204 in the domain 1203. Similarly, the terminal 1B displays the image 1205 at the position 1204. The terminal 1B side is restricted so as not to display the shared images other than the image 1205 displayed by the terminal 1A side in the domain 1203. Further, if necessary, the authority described above may be transferred between the users. As a result, the shared image specified by the user who has the authority is preferentially displayed in the domain 1203. It is possible to prevent a plurality of shared images by each user from being mixed, and this makes it possible to cause the users to view the shared image easily.

### [Effects and the Like]

As described above, information terminal apparatus of the first embodiment, it is possible to realize the position recognition sharing among the terminals on the basis of the calculation of the relationship of the coordinate systems among the terminals, in other words, conversion for sharing the coordinate systems even in a case where there is no suitable real object, such as an anchor or a mark, in the real space. Each user can share position recognition with little effort, and this makes it possible to make efficient work between the users.

As a modification example of the first embodiment, the specific direction in the amounts is not limited to the vertical downward direction illustrated in FIG. 5 (or a gravitational acceleration direction), but may be a terrestrial magnetism direction (for example, a northward direction). The terrestrial magnetism direction can be measured by the geomagnetism sensor 43 illustrated in FIG. 3.

### [Modification Example]

When the inter-terminal vectors (P_{BA}, P_{AB}) illustrated in FIG. 5 are measured by the respective terminals 1 described above (Steps S3A, S3B in FIG. 8), in order to ensure accuracy, it is necessary to cause measurement timing of both terminals 1 to be almost simultaneous, and cause positions of the terminals 1 to be in a constant and stationary state. In the first embodiment, it is assumed that the measurement is executed with a time difference so small that the change in the position of the terminal 1 can be ignored. In the modification example of the first embodiment, a method of allowing a gap of measurement timing of the terminals 1 to be paired and correcting the gap to realize high accuracy will be described.

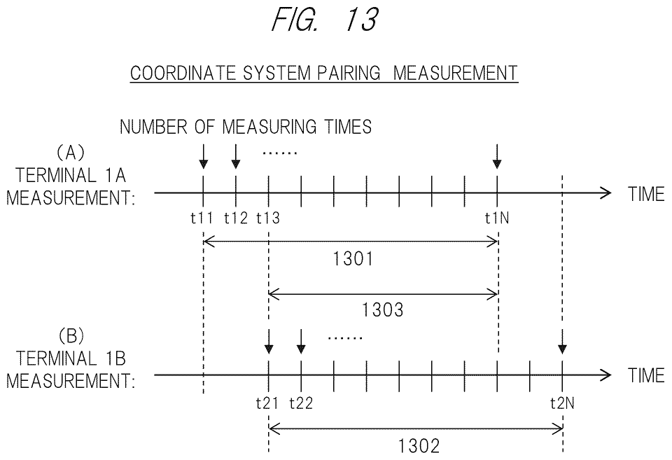

FIG. 13 illustrates measurement of amounts at the time of coordinate system pairing according to the modification example of the first embodiment. (A) at an upper side thereof illustrates measurement timing of the amounts by the terminal 1A, and (B) at a lower side thereof illustrates measurement timing of the amounts by the terminal 1B. A horizontal axis denotes a time, a period 1301 denotes a measurement period of the terminal 1A, a period 1302 denotes a measurement period of the terminal 1B, and a period 1303 denotes a period in which the measurement period of the terminal 1A overlaps with the measurement period of the terminal 1B. Time points t11, t21 and the like denote the number of measurements.

In the modification example, during the coordinate system pairing, each of the terminals 1 executes a plurality of measurements of the amounts (for example, an inter-terminal vector) during the period. Then, each of the terminals 1 obtains and uses estimated values of the amounts at the same timing by complementing the measured values between the terminals 1.

First, in a case where there is a time difference between internal clocks of both the terminals 1, the time difference is corrected at the time of establishment of communication (Steps S1A, S1B) described above. Each of the terminals 1 (1A, 1B) to be paired executes measurement of the amounts a plurality of times during a period while adjusting timing to an extent. The period and the time of the measurement by each of the terminals 1 may not match with each other so long as they have an overlapping period 1303. In the present embodiment, the terminal 1A executes the measurement N times from a time point t11 to a time point t1N in the period 1301. The terminal 1B executes the measurement N times from a time point t21 to a time point t2N in the later period 1302.

Here, an amount measurement of targets at a measurement time tan in the terminal 1A is D_{A}(t_{An}), and an amount of measurement targets at a measurement time t_{Bn} in the terminal 1B is D_{B}(t_{Bn}). In a case where a certain time in the overlapping period 1303 is to, a value at the time to is estimated by interpolation from measured values of the measurement times before and after the time t0. Assuming that the measurement times before and after the time t0 are t_{An}, t_{A(n+1)}, t_{Bn′}, and t_{B(n′+1)}, t_{An}≤t0<t_{A(n+1)}, and t_{Bn′}≤t0<t_{B(n′+1)}. In this case, for example, the estimated values are obtained by the following formulas.

$${D}_{A} ( {t}_{0} ) = \{ ( {t}_{A ( n + 1 )} - t 0 ) {D}_{A} ( {t}_{An} ) + ( t 0 - {t}_{An} ) {D}_{A} ( {t}_{A ( n + 1 )} ) \} / ( {t}_{A ( n + 1 )} - {t}_{An} )$$

$${D}_{B} ( {t}_{0} ) = \{ ( {t}_{B ( {n}^{′} + 1 )} - t 0 ) {D}_{B} ( {t}_{Bn} ) + ( t 0 - {t}_{Bn}^{′} ) {D}_{A} ( {t}_{B ( {n}^{′} + 1 )} ) \} / ( {t}_{B ( {n}^{′} + 1 )} - {t}_{Bn}^{′} )$$

Note that the estimating method is not limited to the above example, and other methods, for example, a method using high-order formula in which many measured values are used may be adopted.

### Second Embodiment

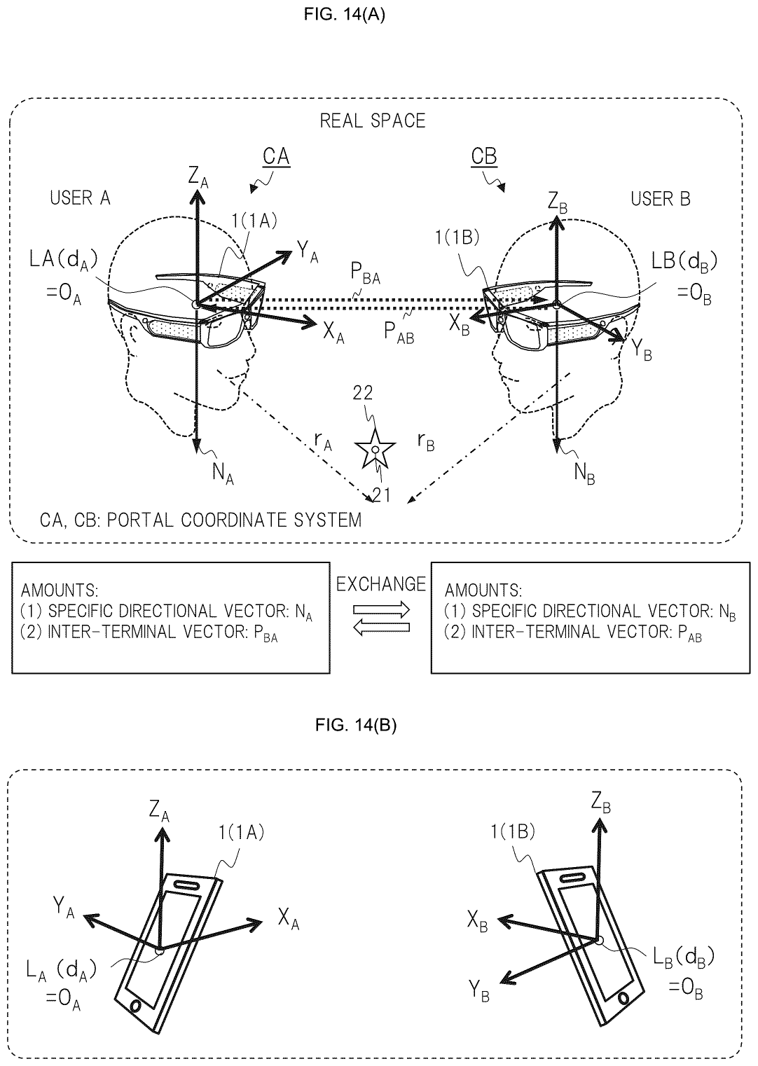

An information terminal apparatus according to a second embodiment of the present invention will be described with reference to FIGS. 14(A)-14(B). Hereinafter, components in the second embodiment different from those in the first embodiment will be described. In the first embodiment, the case where the coordinate systems are shared between the terminals 1 by using the world coordinate systems that have already been set to the respective terminals 1, and the general case where the origin of the world coordinate system and the position of the corresponding terminal 1 are different from each other have been described. Further, in the first embodiment, the case where the coordinate value of the position of the terminal 1 in each world coordinate system is used as one amount has been described. In the second embodiment, at the time of coordinate system pairing between terminals 1, each world coordinate system is reset, and a coordinate system centered on a position of each of the terminals 1 (origin) is set as a coordinate system for position recognition sharing. For the sake of explanation, this coordinate system newly set will be referred to as a portal coordinate system. In the second embodiment, the position recognition sharing is executed using this portal coordinate system.

FIGS. 14(A)-14(B) illustrate an example of the position recognition sharing according to the second embodiment. FIG. 14(A) illustrates a case of HMDs, and FIG. 14(B) illustrates a case of smartphones in the similar manner. At the time of coordinate system pairing between a terminal 1A and a terminal 1B, each of the terminals 1 (1A, 1B) sets a portal coordinate system in which its own position (LA, LB) is set to a coordinate origin. The second embodiment has a step of setting a portal coordinate system by resetting a world coordinate system after a process of a request and a response of the coordinate system pairing at Steps S2A, S2B in the control flow illustrated in FIG. 8, for example.

For example, the terminal 1A sets a portal coordinate system CA, and the terminal 1B sets a portal coordinate system CB. The portal coordinate system CA is set so that an origin O_{A} in a world coordinate system WA of the terminal 1A is aligned with the position LA at that time (a coordinate value d_{A}). Namely, the portal coordinate system CA has the origin O_{A} and each of axes (X_{A}, Y_{A}, Z_{A}). The position LA of the terminal 1A is the same as the origin O_{A} of the portal coordinate system CA, and the coordinate value d_{A} becomes (0, 0, 0). Directions of the respective axes (X_{A}, Y_{A}, Z_{A}) in the portal coordinate system CA are set so that the axis Z_{A} is matched with a vertical upward direction and the axis X_{A} is matched with a front direction of the terminal 1, for example. The portal coordinate system CB of the terminal 1B is also set in the similar manner.

In the second embodiment, the position of the terminal 1 becomes the origin by resetting the world coordinate system. Thus, as amounts at the time of the coordinate system pairing, there may be two elements of (1) a specific directional vector and (2) an inter-terminal vector. Alternatively, it is the same even though they are transferred after the coordinate values d_{A}, d_{B} are set to zero.

In the first embodiment, there is the term “q_{BA}d_{A}q_{BA}*” in Formula A described above for obtaining the origin coordinate value representation. For this reason, in a case where the coordinate value d_{A} is large, an error of the rotation q_{BA} has a great influence. On the other hand, in the second embodiment, since the coordinate value d_{A} becomes zero by the resetting, it is possible to prevent the influence of such an error of the rotation q_{BA}.

Moreover, the setting of the portal coordinate system is not limited to the configuration in which the origin is matched with the central position of the terminal 1 as described above, and any configuration is possible so long as values of the coordinate values d_{A}, d_{B} are sufficiently small. For example, it may be configured so that the origin of the portal coordinate system is arranged in the vicinity of the central position of the terminal 1, such as the central position of a head of the user or a position in front of the head. In a case where the coordinate values d_{A}, d_{B} are sufficiently small, it is possible to reduce the influence of the error of the rotation q_{BA}.

More specifically, the timing of newly setting a portal coordinate system may be matched with timing of measuring an inter-terminal vector from the own terminal 1 to the terminal 1 of the other person. The terminal 1 sets a portal coordinate system having the central position of the own terminal 1 at the time of the measurement as the origin.

Further, in a case where the coordinate system pairing is terminated and the position recognition sharing is then terminated, each of the terminals 1 may cancel the setting of the portal coordinate system, and return to the original setting of the world coordinate system before the coordinate system pairing.

Further, according to the second embodiment, as one of the effects, even in a case where there is an error based on drift of any sensor in the world coordinate system set in the past, it is possible to eliminate the error by the resetting.

### Third Embodiment

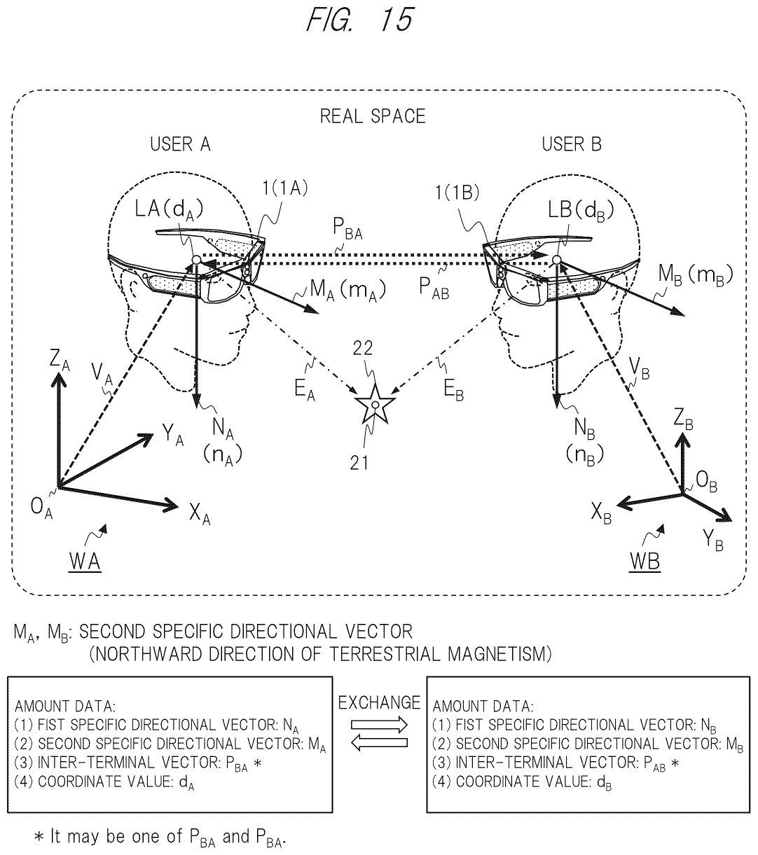

An information terminal apparatus according to a third embodiment of the present invention will be described with reference to FIG. 15. In the first embodiment, one direction (the vertical downward direction) is used as the specific direction. However, in the third embodiment, two specific directions are used. By using a directional vector of these two different specific directions, it is possible to match directions of coordinate systems with each other between terminals of coordinate system pairing. In the third embodiment, for example, by setting a vertical downward direction to a first specific direction, a northward direction of terrestrial magnetism is used as a second specific direction. The northward direction of the terrestrial magnetism can be measured by the geomagnetism sensor 43 illustrated in FIG. 3. Since it is a very special situation that the direction of the terrestrial magnetism becomes a vertical direction, it may be considered that the northward direction of the terrestrial magnetism is actually different from the vertical direction. However, since the direction of the terrestrial magnetism may be affected by structures or the like, it is desirable to measure each time of the coordinate system pairing. In a case where it is known that the influence of the structures or the like is sufficiently small, a setting value of the direction of the terrestrial magnetism, which has been measured and held in advance, may be used.

FIG. 15 illustrates sharing of the coordinate systems according to the third embodiment. Unit directional vectors of a northward direction of terrestrial magnetism in terminals 1 (1A, 1B) are indicated by M_{A}, M_{B}. In the third embodiment, the unit directional vectors M_{A}, M_{B} of the northward direction of the terrestrial magnetism in the terminals 1 (1A, 1B) are used instead of m_{A}, m_{B} that are representations in the respective coordinate systems of the unit vectors in the directions of the inter-terminal vectors P_{BA}, P_{AB} described above. This makes it possible to calculate rotation q_{T} that aligns orientations of respective world coordinate systems WA, WB by the same method as that in the first embodiment.

In order to obtain a difference between coordinate origins, coordinate values d_{A}, d_{B} in the coordinate systems of the respective terminals 1 and at least an inter-terminal vector from one terminal 1 to the other terminal 1 are required. Here, an inter-terminal vector P_{BA} to the terminal 1B when viewed from the terminal 1A is used. If the inter-terminal vector P_{BA} is known, an inter-terminal vector P_{AB} can be calculated.

P_{AB}=−q_{BA}P_{BA}q_{BA}*

Similar to the first embodiment, it is also possible to obtain representation (o_{BA}, o_{AB}) of the coordinate value in the world coordinate system by the own terminal 1 with respect to the origin of the world coordinate system of the other terminal 1, and this makes it possible to obtain conversion formulas for coordinates as described above.

In case of the third embodiment, there is an advantage that the measurement of the inter-terminal vector may be executed by only one terminal 1, for example, the terminal 1 that issues a request for the coordinate system pairing.

### [Modification Example]

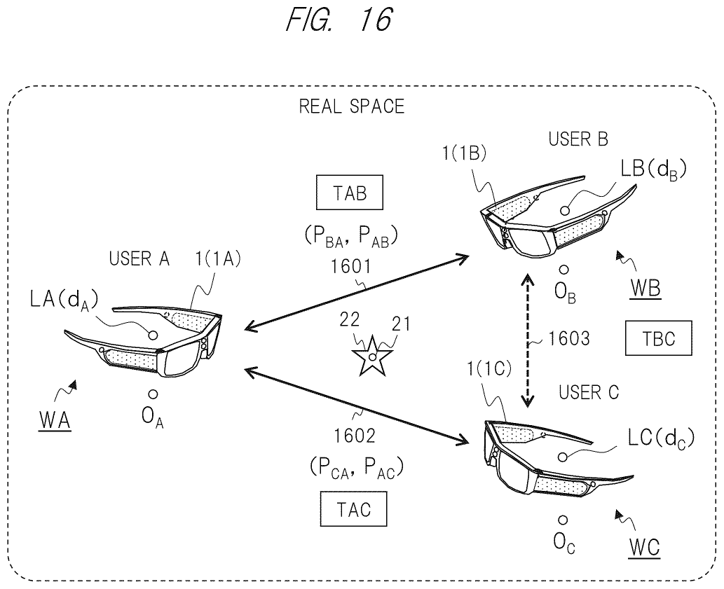

FIG. 16 illustrates a configuration example of coordinate system pairing according to a modification example regarding the first to third embodiments. In this modification example, in a case where there are three of more terminals 1, they execute an operation of coordinate system pairing at the same time. In the present embodiment, there are three terminals 1A, 1B, and 1C as targets, and the three terminals execute coordinate system pairing at the same time. In this configuration example, the terminal 1C of a user C is added. The terminal 1C has a world coordinate system WC, and has a position LC (a coordinate value d_{C}). Illustration of this coordinate system is omitted. In the present embodiment, one of the three the terminals 1, for example, the terminal 1A is used as a main terminal, and the terminals 1B and 1C are used as sub terminal. On the basis of the control flow illustrated in FIG. 8, the three terminals 1 execute processing for the coordinate system pairing at the same time while adjusting timing thereof.

At the time of this processing, the terminal 1B measures a positional relationship 1601 between its own position LB and a position LA of the terminal 1A to obtain an inter-terminal vector P_{AB} and the like. The terminal 1C measures a positional relationship 1602 between its own position LC and the position LA of the terminal 1A to obtain an inter-terminal vector P_{AC} and the like. This makes it possible to obtain a formula of coordinate conversion between the terminal 1A and the terminal 1B (which is referred to as a first conversion parameter TAB) and a formula of coordinate conversion between the terminal 1A and the terminal 1C (which is referred to as a second conversion parameter TAC) almost at the same time. In addition, it is possible to obtain a formula of coordinate conversion regarding a positional relationship 1603 between the terminal 1B and the terminal 1C (which is referred to as a third conversion parameter TBC) from the first conversion parameter TAB and the second conversion parameter TAC.

### Fourth Embodiment

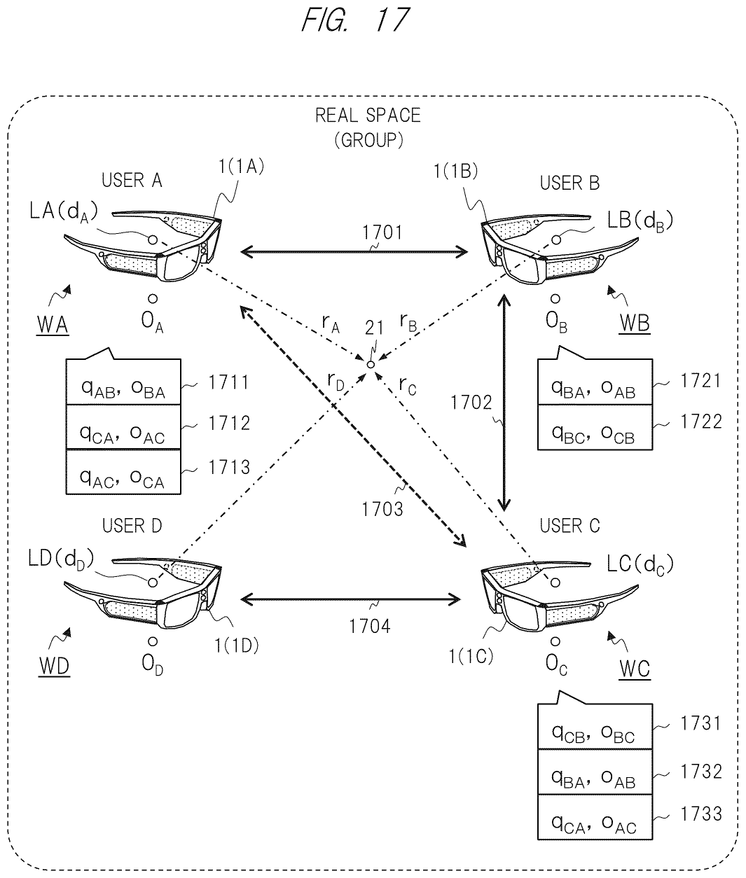

An information terminal apparatus according to a fourth embodiment of the present invention will be described with reference to FIG. 17. In the fourth embodiment, handling and the like in a case where there are three of more terminals 1 that are targets of position recognition sharing will be described. On the basis of the coordinate system pairing between the two terminals. described in the first embodiment and the like, the position recognition sharing is realized even in case of a group of three of more terminals 1.

FIG. 17 illustrates a case where there are terminals 1A, 1B, 1C, 1D associated with users A, B, C, and D as an example of a plurality of terminals 1 of a plurality of users in a real space. Coordinate systems of the terminals 1 are respectively world coordinate systems WA, WB, WC, and WD, and origins thereof are respectively origins O_{A}, O_{B}, O_{C}, and O_{D}. A case where the terminals 1 of these users are used as one group to execute the position recognition sharing will be described. For example, the terminal 1C is an own terminal (a first terminal). First, similarly to the above, for example, coordinate system pairing 1701 between the terminal 1A (a second terminal) and the terminal 1B (a third terminal) is established. From this state, next, coordinate system pairing 1702 between the terminal 1B (the third terminal) and the terminal 1C (the first terminal) is executed. This makes it possible to indirectly establish coordinate system pairing 1703 between the terminal 1A (the second terminal) and the terminal 1C (the first terminal). This will be described below.

First, by the coordinate system pairing 1701, the terminal 1B obtains and holds rotation q_{BA} and origin representation o_{AB} as a conversion parameter 1721. The rotation q_{BA} is rotation by which directional representation based on the world coordinate system WA is changed into directional representation based on the world coordinate system WB. The origin representation o_{AB} is a coordinate value in the world coordinate system WB of the origin O_{A} in the world coordinate system WA. On the contrary, the terminal 1A obtains and holds rotation q_{AB} and origin representation o_{BA} as a conversion parameter 1711.

Next, the coordinate system pairing 1702 between the terminal 1B and the terminal 1C is executed. As a result, the terminal 1C obtains and holds rotation q_{CB} and origin representation o_{BC} as a conversion parameter 1731. The rotation q_{CB} is rotation by which directional representation based on the world coordinate system WB is changed into directional representation based on the world coordinate system WC. The origin representation o_{BC} is a coordinate value in the world coordinate system WC of the origin O_{B} in the world coordinate system WB. On the contrary, the terminal 1B obtains and holds rotation q_{BC} and origin representation o_{CB} as a conversion parameter 1722.

Here, the terminal 1C receives information on the rotation q_{BA} and the origin representation o_{AB} of the conversion parameter 1721 from the terminal 1B. The terminal 1C holds the information as a conversion parameter 1732. As a result, the terminal 1C can use the conversion parameter 1731 (q_{CB}, o_{BC}) and the conversion parameter 1732 (q_{BA}, o_{AB}) to calculate rotation q_{CA} and origin representation o_{AC} with respect to the indirect coordinate system pairing 1703 with the terminal 1A as follows. The rotation q_{CA} is rotation by which directional representation based on the world coordinate system WA is changed into directional representation based on the world coordinate system WC. The origin representation o_{AC} is a coordinate value in the world coordinate system WC of the origin O_{A} the world coordinate system WA.

$${q}_{CA} = {q}_{CB} {q}_{BA}$$

$${o}_{AC} = {o}_{BC} + {q}_{CB} {o}_{AB} {q}_{CB}^{⋆}$$

The terminal 1C holds the obtained information (q_{CA}, o_{AC}) as a conversion parameter 1733. The terminal 1C can use this conversion parameter 1733 to convert representation r_{A} of a position 21 of the terminal 1A in the world coordinate system WA into representation r_{C} of the terminal 1C in the world coordinate system WC as follows.

$${r}_{C} = {q}_{CA} ( {r}_{A} - {o}_{CA} ) {q}_{CA}^{⋆} = {q}_{CA} {r}_{A} {q}_{CA}^{⋆} + {o}_{AC}$$

Further, the terminal 1C transmits information on the conversion parameter 1733 (q_{CA}, o_{AC}) described above to the terminal 1A. The terminal 1A holds the information as a conversion parameter 1712 (q_{CA}, o_{AC}). Then, since there is generally a relationship described below, the terminal 1A can also execute coordinate conversion between the world coordinate system WA and the world coordinate system WC. Namely, the terminal 1A holds a conversion parameter 1713 (q_{AC}, o_{CA}) regarding reverse conversion. Further, since there is a relationship described below, each terminal may hold any one of q_{IJ} and q_{JI}, and hold any one of o_{JI} and o_{IJ}.

$${q}_{IJ} = {q}_{JI}^{⋆}$$

$${o}_{JI} = - {q}_{IJ} {o}_{IJ} = {q}_{IJ}^{⋆}$$

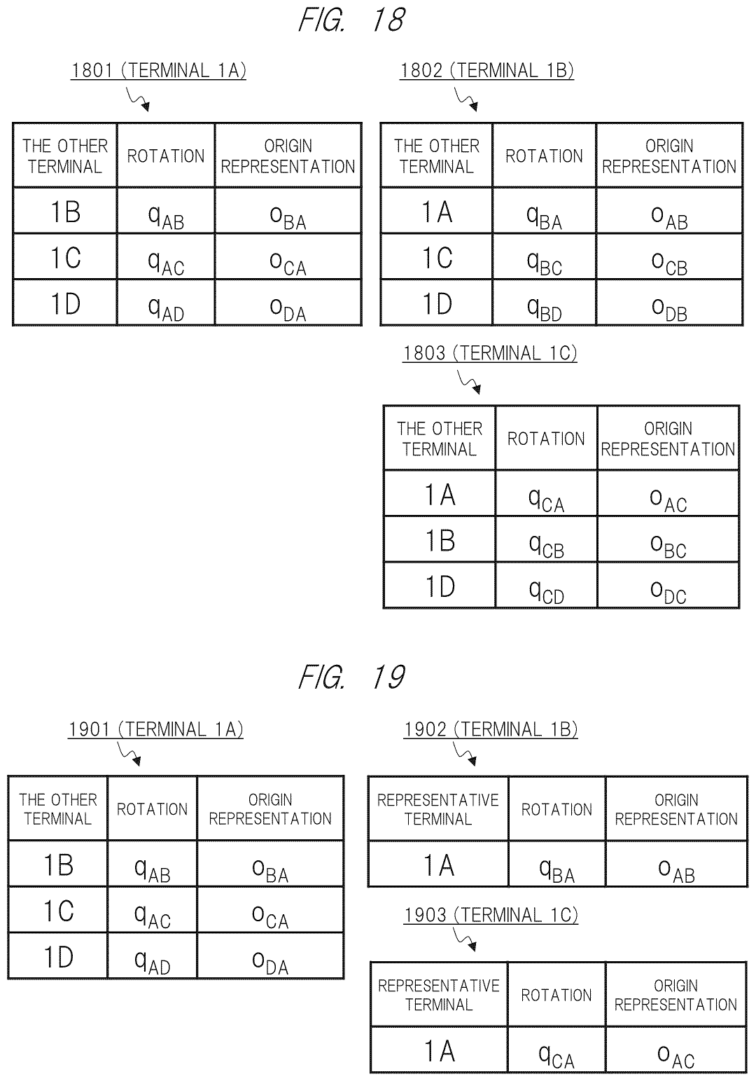

FIG. 18 illustrates a conversion parameter table 1801 held by the terminal 1A, a conversion parameter table 1802 held by the terminal 1B, and a conversion parameter table 1803 held by the terminal 1C in a coordinate system sharing state of the above group. The terminal 1A holds the conversion parameters between each pair while exchanging information with each of the terminals 1 (1B, 1C, 1D) in the group as the other terminal. Specifically, the conversion parameter table 1801 of the terminal 1A has the rotation q_{AB} and the origin representation o_{BA} as the conversion parameter with the terminal 1B, the rotation q_{AC} and the origin representation o_{CA} as the conversion parameter with the terminal 1C, and the rotation q_{AD} and the origin representation o_{DA} as the conversion parameter with the terminal 1D. Similarly, the conversion parameter table 1802 of the terminal 1B has the rotation q_{BA} and the origin representation o_{AB} as the conversion parameter with the terminal 1A, the rotation q_{BC} and the origin representation o_{CB} as the conversion parameter with the terminal 1C, and the rotation q_{BD} and the origin representation o_{DB} as the conversion parameter with the terminal 1D. The conversion parameter table 1803 of the terminal 1C has the rotation q_{CA} and the origin representation o_{AC} as the conversion parameter of the terminal 1A, the rotation q_{CB} and the origin representation o_{BC} as the conversion parameter with the terminal 1B, and the rotation q_{CD} and the origin representation o_{CD} as the conversion parameter with the terminal 1D. The same applies to the terminal 1D.

As described above, it is possible to share the coordinate systems as the indirect coordinate system pairing 1703 between the terminal 1A and the terminal 1C even though a direct process of coordinate system pairing is not executed. Similarly, with respect to the terminal 1D of the user D, it is also possible to share the coordinate systems in the group by executing the similar procedures (for example, coordinate system pairing 1704 or the like) for one terminal 1 (for example, the terminal 1C) in the group. As described above, in the fourth embodiment, in a case where there is a plurality of terminals 1, position recognition sharing in a group is possible by executing coordinate system pairing between two arbitrary terminals 1 in turn. Each of the terminals 1 in the group can transmit a position thereof to the terminal 1 of any other person.

As described above, in the fourth embodiment, a certain terminal 1 (for example, the terminal 1C) executes coordinate system pairing with one terminal 1 (for example, the terminal 1B) of a group for position recognition sharing, and shares conversion parameter among the terminals 1 in the group. This terminal 1 that newly participates in the group does not need to execute direct coordinate system pairing with each of all the terminals 1 in the group. Therefore, this terminal 1 can effectively participate in the sharing group, and requires less user effort.

### [Modification Example (1)]

As a modification example of the fourth embodiment, as well as the second embodiment, a portal coordinate system by resetting a world coordinate system can be applied as a coordinate system of each terminal 1 in a group. For example, when a terminal 1 that newly participates in a certain group (for example, a terminal 1C) executes coordinate system pairing with another terminal 1 in the group, the terminal 1 may set a portal coordinate system. This makes it possible to expect the effect to reduce the influence of the error of the rotation described above with respect to the terminal 1.

In a scene of executing position recognition sharing, a user does not move much from a point where the coordinate system pairing is executed depending upon an application. Therefore, in a case where resetting of a world coordinate system is executed at the time of participation in a group, a change in a positional coordinate of the terminal 1 does not become so large after that. Even though coordinate system pairing with a new terminal 1 is executed in that state, it is possible to expect that the influence of the error of the rotation described above will not become large.

### [Modification Example (2)]

In the fourth embodiment, as illustrated in FIG. 18, a terminal 1 in a group (for example, a terminal 1A) held a conversion parameter with each of the terminals 1 in the group. A method of holding the conversion parameter is not limited to this. In a modification example of the fourth embodiment, a representative terminal 1 in a group (which is referred to as a “representative terminal”) is provided, each of the other terminals 1 holds a conversion parameter for coordinate conversion with the representative terminal.

FIG. 19 illustrates a configuration example of conversion parameters in the modification example. it is assumed that there is a group similar to that illustrated in FIG. 17 and FIG. 18 (terminals 1A to 1D). For example, the terminal 1A is a representative terminal. FIG. 19 illustrates a conversion parameter table 1901 held by the terminal 1A, a conversion parameter table 1902 held by the terminal 1B, and a conversion parameter table 1903 held by the terminal 1C. In this group, a world coordinate system WA of the terminal 1A that is the representative terminal becomes a reference of image display. Further, image data for being displayed at a shared position thus specified are shared in the group by using the world coordinate system WA of the representative terminal as a reference.

The conversion parameter table 1901 of the representative terminal has conversion parameter information with each of the terminals 1 in the similar manner to the conversion parameter table 1801 illustrated in FIG. 18. The conversion parameter table 1902 of the terminal 1B has rotation q_{BA} and origin representation o_{AB} as a conversion parameter with the representative terminal. The conversion parameter table 1903 of the terminal 1C has rotation q_{CA} and origin representation o_{AC} as a conversion parameter with the representative terminal. In a case where a new terminal 1 (for example, the terminal 1D) participates in an existing group, the terminal 1D executes coordinate system pairing with the representative terminal, for example. Similarly, the terminal 1D may hold the conversion parameter information with the representative terminal. Further, even in a case where the terminal 1D executes coordinate system pairing with any terminal other than the representative terminal in the existing group, it is possible to indirectly obtain the conversion parameter with representative terminal in the similar manner to the method described above.

As an image display example in the group, in a case where the terminal 1B wants to display an image at a certain position 21, the terminal 1B converts representation of the position 21 (a positional coordinate value r_{B}) into representation of a position (a positional coordinate value r_{A}) in the world coordinate system WA of the representative terminal by using the conversion parameter table 1902, and transmits information on the position and the image to the representative terminal. Alternatively, the representative terminal may convert the positional coordinate value r_{B} into the positional coordinate value r_{A} in the world coordinate system WA by using the conversion parameter table 1901. The representative terminal transmits information on the position and the image thus obtained to the other terminals 1C and 1D in the group. Each of the terminals 1C and 1D converts it into representation of a position in its own coordinate system in accordance with the obtained information on the position and the image, and displays the image at the position. Alternatively, the representative terminal may convert the positional coordinate value r_{A} into representation of the position (r_{C}, r_{D}) in the respective world coordinate systems WC and WD by using the conversion parameter table 1901, and transmit it to the terminals 1C and 1D.

In this modification example, each of the terminals 1 other than the representative terminal only needs to hold the conversion parameter information with the representative terminal, and this simplifies preparation and management of the conversion parameter information in the entire system. As another modification example, a form in which only the representative terminal holds the conversion parameter information on the other terminals and executes each conversion.

### [Modification Example (3)]

In the modification example (2) described above, an exchange positional information between the terminals in the group may be executed on the basis of the positional coordinate value r_{A} in the world coordinate system WA. In this case, each of the terminals other than the representative terminal converts position representation in the world coordinate system WA into representation in the world coordinate system of the own terminal in the own terminal. In this modification example, the representative terminal may not hold the conversion parameter with each of the terminals, and this simplifies preparation and management of information on the parameters in the entire system as well as the modification example (2) described above. Further, it is possible to exchange position data without going through the representative terminal, and this simplifies the exchange of the data.

As described above, the present invention has specifically been described on the basis of the embodiments. However, the present invention is not limited to the embodiments described above, and the present invention may be modified into various forms without departing from the substance thereof.

### REFERENCE SIGNS LIST

1, 1A, 1B . . . information terminal apparatus, 21 . . . position, 22 . . . image, 501, 502 . . . amount data, WA, WB . . . world coordinate system, LA, LB . . . position, TA, TB . . . conversion parameter.

1. An information terminal apparatus comprising a position and orientation sensor,
wherein the information terminal apparatus measures the position and orientation of said terminal in a first world coordinate system using the position and orientation sensor,
acquires specific direction information of two different specific directions of the external world represented in a second world coordinate system, and information of a single location in the external world,
determines the representation of the two different specific directions of the external world in the first world coordinate system, determines the representation of the single location of the external world in the first world coordinate system,
recognizes position the external world of represented in the second world coordinate system based on the first world coordinate system by conversion between the first world coordinate system and the second world coordinate system.

2. The information terminal apparatus according to claim 1,
wherein the specific directions include a vertical downward direction or gravitational acceleration direction, or a terrestrial magnetism direction, and
wherein the vector representation of the specific directions in the first world coordinate system is determined based on measurements by the position and orientation sensor.

3. The information terminal apparatus according to claim 1, comprising a distance measuring sensor,
wherein at least one of the specific directions is determined as a vector representation between two points in the external world in the first world coordinate system using measurements by the distance measuring sensor.

4. The information terminal apparatus according to claim 1, comprising a distance measuring sensor,
wherein a coordinate value representation of the location in the external world in the first world coordinate system is determined based on measurements by the distance measuring sensor.

5. The information terminal apparatus according to claim 1, comprising a display device,
wherein a virtual object is displayed at a specified position in the second world coordinate system.

6. A position recognition method for an information terminal apparatus comprising a position and orientation sensor, the method comprising:
measuring the position and orientation of said terminal in a first world coordinate system using the position and orientation sensor,
acquiring specific direction information of two different specific directions represented in a second world coordinate system and coordinate value information of a location in the external world,
determining the representations of the two different specific directions in the first world coordinate system,
determining the representation of the location in the external world in the first world coordinate system,
recognizing the position of the external world represented in the second world coordinate system based on the first world coordinate system by conversion between the first world coordinate system and the second coordinate system.

7. The position recognition method according to claim 6,
wherein the specific directions include a vertical downward direction or gravitational acceleration direction, or a terrestrial magnetism direction, and
wherein the vector representation of the specific directions in the first world coordinate system is determined based on measurements by the position and orientation sensor.

8. The position recognition method according to claim 6,
wherein the information terminal apparatus further comprises a distance measuring sensor,
the method further comprising a step of determining at least one of the specific directions as a vector representation between two points in the external world in the first world coordinate system based on measurements by the distance measuring sensor.

9. The position recognition method according to claim 6,
wherein the information terminal apparatus further comprises a distance measuring sensor,
the method further comprising a step of determining the coordinate value representation of the location in the external world in the first world coordinate system based on measurements by the distance measuring sensor.
